(19) United States
(12) Patent Application Publication
(10) Pub. No.: US 2021/0326908 A1
(43) Pub. Date: Oct. 21, 2021

(54) GUIDING ACQUISITION OF INFORMATION IN A SOCIAL NETWORK

(71) Applicant: AFFINIO INC., Halifax (CA)

(72) Inventor: Philip Joseph RENAUD, Toronto (CA)

(21) Appl. No.: 16/757,744

(22) PCT Filed: Nov. 2, 2018
(86) PCT No.: PCT/IB2018/058640

§ 371 Date: Mar. 19, 2021

Related U.S. Application Data
(60) Provisional application No. 62/580,809, filed on Nov. 2, 2017.

(51) Int. Cl. G06Q 30/02; G06Q 50/00

(52) U.S. Cl. CPC G06Q 30/0201; G06Q 50/01

(57) ABSTRACT

Methods and apparatus for guiding article selection from a vast collection of articles are disclosed. Inter-article affinity measures are determined based on individual article characteristics and network-users' successive access to articles. For each detected access to an article, the apparatus determines a complementing article according to the inter-article affinity measures and communicates an identifier of the complementing article to a respective user. The apparatus employs multiple hardware processor and maintains a registry of article-selection data, for active users detected by the apparatus, and a storage medium storing inter-article transition scores and inter-article affinity coefficients which are continually updated.

### CROSS-REFERENCE TO RELATED APPLICATIONS

The present application claims the benefit of provisional application 62/580,809 filed on Nov. 2, 2017, titled “Identifying attuned article succession in a vast article collection”, the entire content of which is incorporated herein by reference.

### FIELD OF THE INVENTION

The present invention relates to users' access to information through an information dissemination system. In particular, the invention is directed to identifying users' information-access patterns and guiding users' acquisition of information of interest from massive information sources.

### BACKGROUND

Marketing intelligence may rely on identifying consumers' interests, helping consumers to find respective relevant material, and presenting material provided by specific providers of products and/or services. With the widespread access to the Internet, the Internet users may be viewed as the consumer community. Marketing intelligence may then be directed towards identifying users' information-access patterns and guiding users' acquisition of information of interest from information sources. The process of identifying users' information-access patterns, as applied to a sizeable collection of articles, is computationally intensive and the required computational effort increases significantly as the number of articles increases. The term “article” refers to information stored in a medium in the form of text, image, audio signal, and/or video signal.

Therefore there is a need to explore methods and apparatus for real-time determination of appropriate article successions for an Information Dissemination System providing access to a large number of articles.

### SUMMARY

Methods and apparatus for real-time determination of interrelated articles within a collection of articles accessible through an Information Dissemination System are disclosed. The apparatus employs multiple hardware processors organized as a cascade of sets of parallel processors. Identifying interrelated articles is based on content similarity to a currently inspected article as well as usage data indicating past users' access to successive articles.

In accordance with an aspect, the invention provides a method of guiding article selection from a plurality of articles accessible to a plurality of users. The method comprises processes of: initializing a compliance score; initializing a set of global article successions; and acquiring similarity metrics of each article to designated articles of the plurality of articles. Upon identifying a selected user accessing a specific article; a process of determining a complementing article to the specific article based on at least the similarity metrics and the set of global article successions which is based on detecting article access. An identifier of the complementing article is communicated to the selected user. Upon detecting access to a subsequent article by the selected user, the compliance score is updated and the set of global article successions is updated to account for a transition from the specific article to the subsequent article. Consequently, the method guides acquisition of information from a massive information source.

The method further comprises acquiring characteristics of each cluster of a set of predetermined clusters of users having access to the plurality of articles, initializing sets of cluster-specific article successions, each set of cluster-specific article successions corresponding to a respective cluster of users, and associating the selected user with a specific cluster.

A respective set of cluster-specific article successions corresponding to the specific cluster is updated and the process of determining the complementing article of the specific article is revised based on the similarity metrics, the set of global article successions, and the sets of cluster-specific article successions.

Data comprising the specific article, the complementary article, and a timestamp of communicating the identifier of the complementing article to the selected user is retained. A time interval between a time indication of detecting the subsequent article and the timestamp is determined and the compliance score is updated subject to a determination that the subsequent article matches the complementary article and the time interval is less than a predefined time threshold.

According to one implementation, the method further comprises segmenting the plurality of articles into a collection of primary articles and a collection of secondary articles; and selecting the designated articles from the collection of primary articles. Thus, the complementing article is restricted to be within the collection of primary articles.

In accordance with another aspect, the invention provides an apparatus for guiding article selection from a plurality of articles. According to an embodiment, the apparatus comprises a first set of memory devices storing inter-article affinity data and a second set of memory devices storing processor executable instructions. The instructions are arranged into three modules which may share a processor or—preferably—share respective processors.

A first module 520 causes a first processor (or a shared processor) to select complementing articles to reference articles of the plurality of articles based on inter-article affinity coefficients derived from the inter-article affinity data;

A second module causes a second processor (or the shared processor) to update inter-article affinity data according to observed article successions to the reference articles.

A third module causing a third processor (or the shared processor) to compute inter-article composite affinity coefficients based on the inter-article affinity data.

Therefore, the apparatus guides acquisition of information from an information source.

The first module is configured to identify a current user accessing a particular article, select a complementing article from the plurality of articles according to the composite affinity coefficients, and communicate information relevant to the complementing article to the current user. The first module is further configured to associate the current user with a respective cluster of a number of predetermined user clusters.

The second module is configured to identify latest preceding article accessed by the current user, increase an inter-article gravitation score of 2-tuple {latest-preceding-article, particular article}, and increase an inter-article attraction score of 3-tuple {latest-preceding-article, particular article, respective cluster}.

The second module is further configured to identify latest complementing article recommended to the user and update a compliance score subject to a determination that the particular article is the latest complementing article.

The first module is further configured to initialize a registry of active users as an empty registry and enter the current user in the registry subject to a determination that the current user is not indicated in the registry.

For each directed article pair, the inter-article affinity data comprises a similarity coefficient, a gravitation score 150, and an attraction score. Each composite-affinity coefficient is determined as a function of a similarity coefficient, a gravitation score, and an attraction score of a respective directed article pair.

In an optional implementation, the first module is further configured to segment the plurality of articles into a collection of primary articles and a collection of secondary articles, and derive the inter-article affinity coefficients for only directed article pairs directed to primary articles.

In accordance with a further aspect, the invention provides of guiding article selection from a plurality of articles accessible to a plurality of users. The method comprises: acquiring at a network interface metadata of each detected article of a stream of detected articles belonging to the plurality of articles, the metadata being a tuple including an article identifier and an identifier of an associated; and cyclically distributing individual metadata of the stream of detected articles to multiple input buffers, each input buffer coupled to a respective processor of a plurality of processors.

Each processor executes instructions for: extracting metadata of a specific article stored in a respective input buffer; obtaining relevant affinity coefficients between the specific article and designated articles of the plurality of articles from a data memory storing inter-article affinity coefficients; and determining a complementing article to the specific article based on the relevant affinity coefficients. An identifier of the complementing article is communicated to an associated user of the specific article. Therefore, the method guides information acquisition from a massive information source.

Obtaining the relevant affinity coefficients between the specific article and the designated articles comprises employing a dual selector to cyclically connect the plurality of processors to the data memory and reading the relevant affinity coefficients from the data memory.

The method further comprises acquiring characteristics of each cluster of a set of predetermined clusters of the plurality of users and determining a specific cluster to which the associated user belongs.

The method further comprises updating a registry of active users indicating for each active user a respective sequence of accessed articles and corresponding complementing articles; an active user being a user that has accessed a detected article.

The method further comprises each processor accessing the registry of active users for: identifying latest preceding article accessed by the associated user, increasing an inter-article gravitation score of a 2-tuple {latest-preceding-article, specific article}, and increasing an inter-article attraction score of 3-tuple {latest-preceding-article, specific article, specific cluster}.

Each processor accesses the registry of active users to insert the identifier of the complementing article relevant to the associated user for use in determining a compliance score.

Generally, a composite affinity coefficient for a directed pair of a first article and a second article is determined as a function of a similarity metric of the first article and the second article, a gravitation score of the second article to the first article; and an attraction score of the second article to the first article for a specific cluster of users.

In accordance with a further aspect, the invention provides an apparatus for guiding article selection from a plurality of articles accessible to a plurality of users. The apparatus comprises: a plurality of hardware processors; a plurality of input buffers each coupled to a respective processor of the plurality of processors; and a data memory storing inter-article affinity scores and inter-article affinity coefficients.

A network interface, comprising a respective processor, executes instructions for detecting users' selection of articles through a network, and acquiring corresponding metadata.

A distributor is configured to cyclically distribute metadata of detected articles to individual input buffers of the plurality of input buffers.

A dual selector is configured to cyclically provide two-way access of individual processors of the plurality of processors to the data memory.

Each processor executes instructions to: identify a detected article and associated user from metadata held in a respective input buffer; determine a complementing article of the detected article based on relevant affinity coefficients retrieved from the data memory; and communicate an identifier of the complementing article to the associated user through the network interface.

Therefore, the apparatus guides acquisition of information from an information source.

The apparatus further comprises a plurality of output buffers each coupled to a respective processor of the plurality of processors. The processors transfer identifiers of complementing articles to respective output buffers.
The apparatus further comprises a registry of active users, coupled to the network interface, for storing article-selection data for active users, and a combiner for cyclically distributing identifiers of complementing articles determined at the plurality of processors to the network interface for transmission to respective users.

In accordance with a further aspect, the invention provides a method of guiding article selection from a plurality of articles accessible to a plurality of users. The method comprises: acquiring at a network interface metadata of each detected article of a stream of detected articles belonging to the plurality of articles, the metadata being a tuple including an article identifier and an identifier of an associated; and distributing individual metadata of the stream of detected articles to a plurality of input buffers, each input buffer coupled to a respective processor of a plurality of hardware processors, each assigned to a partition of articles of the plurality of articles.

Each processor executes instructions for: extracting metadata of a specific article stored in a respective input buffer; obtaining relevant affinity coefficients between the specific article and designated articles of the plurality of articles from a data memory storing inter-article affinity coefficients for a respective partition of articles to which the specific article belongs; and determining a complementing article to the specific article based on the relevant affinity coefficients. An identifier of the complementing article is communicated to an associated user of the specific article.

Consequently, the method guides information acquisition from a massive information source.

The method further comprises updating a registry of active users indicating for each active user a respective sequence of accessed articles and corresponding complementing articles, where an active user is a user that has accessed a detected article.

The method further comprises each processor accessing the registry of active users for: identifying latest preceding article accessed by the associated user; increasing an inter-article gravitation score of a 2-tuple {latest-preceding-article, specific article}; and increasing an inter-article attraction score of 3-tuple {latest-preceding-article, specific article, specific cluster}.

The processors access the registry of active users to insert identifiers of complementing articles relevant to respective users for use in determining a compliance score.

In accordance with a further aspect, the invention provides an apparatus for guiding article selection from a plurality of articles accessible to a plurality of users. The apparatus comprises: a plurality of hardware processors, each designated for a partition of articles of the plurality of articles; and a plurality of input buffers each coupled to a respective processor of the plurality of processors.

A network interface comprising a respective processor, executes instructions for: detecting users' selection of articles through a network; and acquiring corresponding metadata.

Each data memory of a plurality of data memory devices stores inter-article affinity scores and inter-article affinity coefficients 170 for a respective partition of articles.

A distributor distributes metadata of detected articles to respective processors of the plurality of processors. Each processor is coupled to a respective data memory and executes instructions to: identify a detected article and associated user from metadata held in a respective input buffer; determine a complementing article of the detected article based on relevant affinity coefficients retrieved from the respective data memory; and communicate an identifier of the complementing article to the associated user through the network interface 990.

Therefore, the apparatus guides acquisition of information from an information source.

The apparatus further comprises a registry of active users, coupled to the network interface 990, storing article-selection data for active users; and means for communicating identifiers of complementing articles determined at the plurality of processors 930 to the network interface for transmission to respective users.

The apparatus further comprises a plurality of output buffers each coupled to a respective processor of the plurality of processors. Each processor transfers identifiers of complementing articles to a respective output buffer for further processing.

The apparatus further comprises a dual cyclic selector for connecting the plurality of processors to the registry of active users to enable communicating article-succession records from the registry to the plurality of processors and communicating identifiers of complementing articles to the registry of active users.

The apparatus further comprises at least one processor for determining inter-article composite-affinity coefficients, based on respective inter-article similarity levels, inter-article gravitation scores, and inter-article attraction scores, for directed pairs comprising each article of the plurality of articles to each article of a subset of articles designated as primary articles.

### BRIEF DESCRIPTION OF THE DRAWINGS

Embodiments of the present invention will be further described with reference to the accompanying exemplary drawings, in which:

FIG. 1 illustrates requisite raw data (input data) for enabling identification of interrelated articles from among a massive collection of articles, analytic data extracted from the raw data, and distilled data indicating recommended articles to succeed each article, in accordance with an embodiment of the present invention;

FIG. 2 illustrates a system for influencing article selection, in accordance with an embodiment of the present invention;

FIG. 3 illustrates an active-users registry to facilitate tracking a user's successive access to articles;

FIG. 4 illustrates data structures for organizing data relevant to significant inter-article similarity levels, significant gravitation levels, and significant attraction levels;

FIG. 5 illustrates an apparatus comprising three modules, labelled Module-I, Module-II, and Module-III, for determining complementing article successions for a mature information tracking system with sufficient usage data to determine inter-article gravitation level and attraction levels, in accordance with an embodiment of the present invention;

FIG. 6 illustrates a software system for determining favourite article successions for a young information tracking system with insufficient usage data, in accordance with an embodiment of the present invention;

FIG. 7 illustrates a software system for updating usage data

FIG. 8 is a schematic of an apparatus implementing the software system of FIG. 5 for determining favourite article successions, in accordance with an embodiment of the present invention;

FIG. 9 illustrates equipment implementing Module-I of the software system of FIG. 5 comprising multiple hardware processors for identifying a number of harmonious articles to follow a currently accessed article based on composite-affinity levels, in accordance with an embodiment of the present invention;

FIG. 10 illustrates equipment implementing Module-II of the software system of FIG. 5 employing multiple hardware processors for updating inter-article gravitation scores and attraction scores, in accordance with an embodiment of the present invention;

FIG. 11 illustrates equipment implementing Module-III the software system of FIG. 5 employing multiple hardware processors to generate or update the composite-affinity levels used in Module-I of the software system of FIG. 5. The composite-affinity levels are based on the inter-article similarity levels, the inter-article gravitation scores, and the attraction scores illustrated in FIG. 5, in accordance with an embodiment of the present invention;

FIG. 12 illustrates generation of the composite affinity coefficients starting with inter-article similarity coefficients, in accordance with an embodiment of the present invention;

FIG. 13 illustrates exemplary article transitions necessitating bulk-data updates and concise data updates;

FIG. 14 illustrates a first scheme of partitioning bulk-data and concise data for storage in separate memory devices for concurrent processing in accordance with an embodiment of the present invention;

FIG. 15 illustrates a second scheme of partitioning bulk-data and concise data for storage in separate memory devices for concurrent processing in accordance with an embodiment of the present invention;

FIG. 16 illustrates an alternative implementation of Module-I of the software system of FIG. 5 where, instead of cyclic access to processors 930 as illustrated in FIG. 9, each processor handles articles of a respective partition of the plurality of article, in accordance with an embodiment of the present invention;

FIG. 17 illustrates an alternative implementation of Module-II of the software system of FIG. 5 where, instead of cyclic access to processors 1030 as illustrated in FIG. 10, each processor handles articles of a respective partition of the plurality of article, in accordance with an embodiment of the present invention;

FIG. 18 illustrates an alternative implementation of Module-III the software system of FIG. 5 where, instead of cyclic access to processors 1130 as illustrated in FIG. 11, each processor handles articles of a respective partition of the plurality of article, in accordance with an embodiment of the present invention;

FIG. 19 illustrates timing of processes that follow detecting access of a sequence of articles in an apparatus employing multiple processors;

FIG. 20 illustrates cyclic connection of multiple processors to the registry of active users in order to provide article-succession data (gravity data and attraction data) to the processors and insert identifiers of complementing articles into the registry of active users;

FIG. 21 illustrates connectivity of one of the processors of the equipment of FIG. 9 or the equipment of FIG. 16 to a memory device storing the inter-article affinity data and affinity coefficients illustrated in FIG. 4 and to the registry of active users illustrated in FIG. 4;

FIG. 22 illustrates segmenting a plurality of articles into a collection of primary articles and a collection of secondary articles for use in determining selective complementing articles, in accordance with an embodiment of the present invention;

FIG. 23 illustrates a data structure for storing identifiers of favourite articles recommended to follow a currently accessed article;

FIG. 24 illustrates inter-article similarity levels based on articles' contents; and

FIG. 25 illustrates envisaged users' compliance with article recommendations determined by the software system of FIG. 5.

### REFERENCE NUMERALS

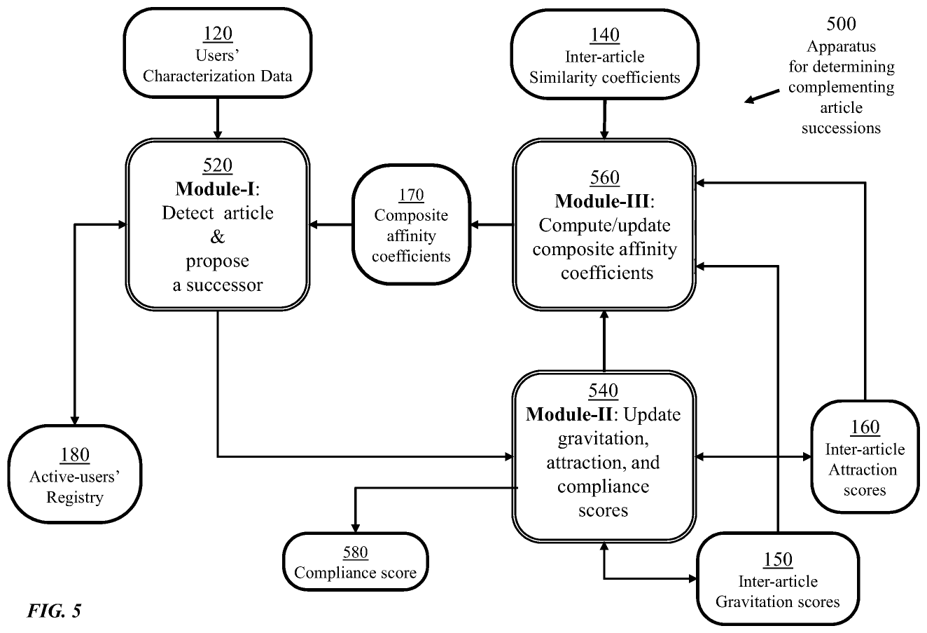

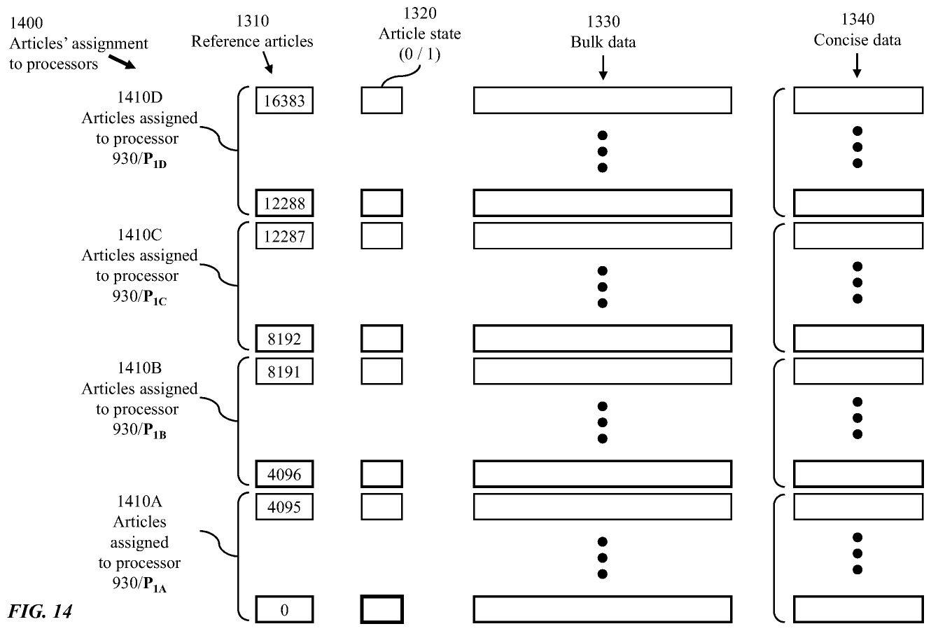

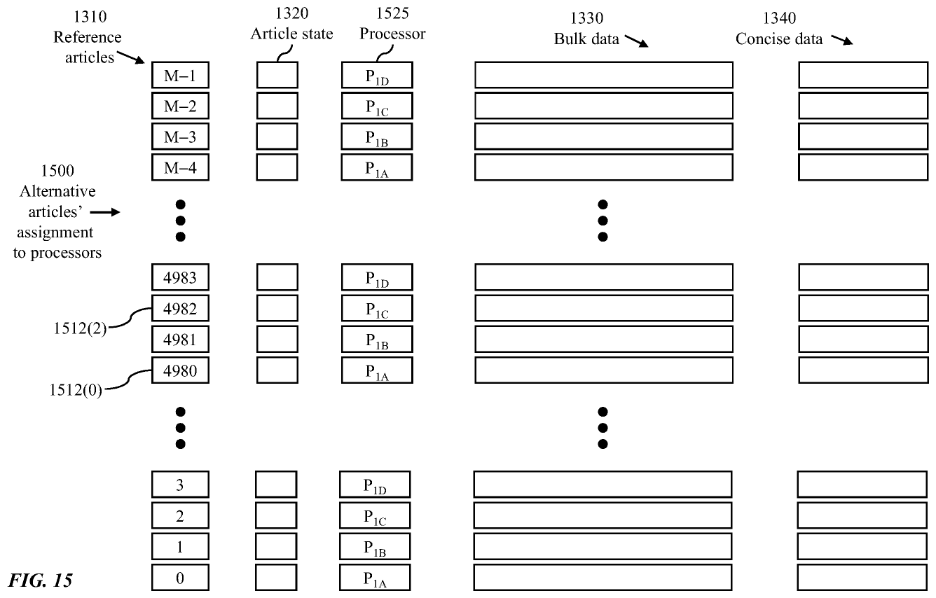

100: Data required for determining harmonious article succession
110: Article characterization data including articles' metadata and content storage address or network address for retrieving articles' contents
120: Users' characterization data including identifiers of clusters of users
130: Usage data including identifiers of accessed articles and succession of articles accessed by a same user
140: Inter-article similarity coefficients based on comparing articles' contents
150: Inter-article gravitation data based on tracking successive articles accessed by a same user regardless of the characteristics of the user
160: Inter-article attraction data based on tracking successive articles accessed by a same user taking into account the user's affiliation such as a cluster to which the user belongs and proximity of descriptors of the user to descriptors of the centroid of the cluster
170: Composite affinity coefficients for directed article pairs
180: Active-users' registry structured to identify users accessing an article during a moving time window or identify a most recently tracked number of users.
200: System for influencing article selection
210: Process of detecting an accessed article and identifying a user
220: Process of selecting a complementing article for a user accessing a current article
230: Process of communicating an identifier of a complementing article to the user
240: A process of detecting a subsequent article accessed by same user
245: Process of updating compliance score
250: Process of updating overall (global) article-succession data
260: Process of updating cluster-specifiv article-succession data, i.e., succession-data relevant to users belonging to a specific cluster of users (a “tribe”)
280: Overall historical article-succession data (also called “gravitation score”)
290: Cluster-specific historical article-succession data (also called “attraction score”)
310: Circular buffer
312: User identifier field
314: Identifier of a specific user
316: User registration field of initial-pointers to users' records
318: Initial pointer to a linked list of a record of a specific user
322: Currently-accessed-article data field
324: Identifier of a currently accessed article by a respective user
332: Proposed-article data field
334: Identifier of an article recommended to a respective user
342: Linked-list pointer
344: Index of relevant subsequent data for a specific user; a null entry indicates absence of subsequent data for the user
350: Index of a linked list
400: Data structures for organizing significant values of similarity coefficients, inter-article gravitation scores, and inter-article attraction scores
410: Indices of a plurality of articles
420: Index of a specific reference article
440: Structure of data relevant to candidate successor articles of significant similarity to respective reference articles
442: Index of a candidate article of significant similarity to a reference article
445: Similarity level
450: Structure of data relevant to candidate successor articles of significant gravitation to respective reference articles
452: Index of a candidate article of significant gravitation to a reference article
455: Gravitation level
460: Structure of data relevant to successor articles of significant attraction to respective reference articles for a specific user cluster.
462: Index of a candidate article of significant attraction to a reference article for a user belonging to a specific cluster of users
465: Attraction level
500: Software system for determining favourite article successions for a “mature system” with sufficient usage data
520: A module for determining a complementing article to a currently selected article to be recommended to a user accessing the selected article
540: A module (software instructions stored in a memory device) for updating a compliance score, inter-article gravitation scores, and inter-article attraction scores
560: A module (software instructions stored in a memory device) for computing composite-affinity coefficients 170 for directed article pairs based on inter-article similarity coefficients 140, gravitation scores 150, and attraction scores 160
580: Compliance score
600: Software system for determining favourite article successions
610: A module (software instructions stored in a memory device) for selecting one of candidate articles to complement a reference article (an article current accessed by a user)
620: Process of detecting article selection by a user
622: Process of determining identifiers of the user and the accessed article
624: Process of identifying a user's cluster (if any) and the user's rank within the cluster
630: Software instructions for recommending an article (the kernel of module 610)
632: Process of communicating the recommended article to the user
640: Process of ascertaining article succession (also called article transition) where a user accesses two or more articles
642: Process of adding a user to the Active-users Registry and providing an initial linked-list pointer for the user
646: Process of updating a linked list of the Active-users' Registry
705: Identifier of a proposed article
710: Process of identifying the most-recent article recommended to a specific user
720: Software instructions to determine compliance, or otherwise, with a recommendation
740: Process of determining the user's compliance with a recommendation and updating a “compliance score”
750: Software instructions for updating gravitation scores
760: Software instructions for updating attraction scores
800: Schematic of a method of updating bulk data and concise data distilled from the bulk data
810: Tracked data received from a network interface
820: Buffer holding input data
825: Memory device holding transition data resulting from execution of Module-I
831: Set of processors executing instructions of Module-I
832: Set of processors executing instructions of Module-II
833: Set of processors executing instructions of Module-III
840: Storage medium (multiple memory devices) holding bulk data (similarity data, gravitation and attraction scores)
850: Memory device storing concise data (composite affinity coefficients)
860: Process of queueing transition data
870: Process of updating gravitation and attraction scores
880: Process of computing composite-affinity coefficients
900: Equipment implementing Module-I of the software system of FIG. 5
910: Selector for distributing tracked data to processors 930
920: Buffer holding tracked data (article identifier, user identifier, etc.)
930: Hardware processor (labelled P_{1A}, P_{1B}, P_{1C}, or P_{1D})
940: Buffer holding a message indicating user's identifier and an identifier of a recommended article determined by a processor 930
950: Combiner of messages produced by processors 930 (labelled P_{1A}, P_{1B}, P_{1C}, and P_{1D})
960: Dual selector for cyclic access to memory device 970 storing composite affinity coefficients 170
962: Dual selector for cyclic access of processors 930 to registry 180 of active users
970: Memory device storing composite affinity coefficients 170
975: Composite affinity coefficients for a specific reference article read from memory device 970
980: Buffer holding data relevant to recommended articles, successor articles, and respective users to be communicated to users through a network interface and provided to Module-II for updating gravitation scores, attraction scores, and overall compliance scores
1000: Equipment implementing Module-II of the software system of FIG. 5
1002: Data from buffer 980
1010: Selector for distributing the data relevant to recommended articles, successive articles, and respective users to processors 1030
1020: Buffer holding data relevant to recommended articles, successor articles, and respective users for updating inter-article gravitation scores and attraction scores for reference articles handled in a respective processor 1030
1030: Hardware processor (labelled P_{2A}, P_{2B}, or P_{2C})
1040: Selector for cyclically connecting processors 1030 (P_{2A}, P_{2B}, and P_{2C}) to memory devices
1050 holding inter-article gravitation scores 150 and inter-article attraction scores 160
1050: Memory devices
1100: Equipment implementing Module-III of the software system of FIG. 5
1120: Memory devices holding inter-article similarity data 140, inter-article gravitation data 150, and inter-article attraction data 160
1130: Hardware processor (labelled P_{3A}, P_{3B}, P_{3C}, or P_{3D})
1132: Selector for cyclically coupling processors 1130 (P_{3A}, P_{3B}, P_{3C}, and P_{3D}) to memory device 1170
1170: Memory device 1170 holding composite affinity coefficients 170
1200: Processes of generating composite affinity coefficients starting with inter-article similarity coefficients
1210: Process of initializing inter-article gravitation scores and attraction scores
1220: Process of acquiring article-characterization data of a collection of articles
1225: Process of determining inter-article similarity coefficients based on articles' content
1230: Process of acquiring article-access data
1240: Process of updating gravitation and attraction scores
1250: Selection of process 1230 or process 1260 according to amount of usage-data
1260: Computing composite affinity coefficients based on similarity coefficients as well as gravitation scores and attraction scores
1300: Article transitions
1310: Reference article
1320: Article state (0: no updates needed, 1: updates of bulk data and concise data needed)
1330: Bulk data for each article
1340: Concise data for each article
1400: A first scheme of articles' assignment to processors
1420: Partition of articles
1500: A second scheme of articles' assignment to processors
1512: Index of an article assigned to a specific processor
1600: Alternative implementation of Module-I of the software system of FIG. 5
1610: Processor selector for a reference article based on the article's partition (FIG. 14 or FIG. 15)
1640: Buffer holding messages indicating users' identifiers and identifiers of recommended articles for reference articles of a respective partition
1670: Memory devices storing composite-affinity coefficients
1671: Memory device storing composite affinity coefficients for a first partition of articles
1672: Memory device storing composite affinity coefficients for a second partition of articles
1673: Memory device storing composite affinity coefficients for a third partition of articles
1674: Memory device storing composite affinity coefficients for a fourth partition of articles
1700: Alternative implementation of Module-II of the software system of FIG. 5
1750: Memory devices storing gravitation and attraction data
1751: Memory device storing gravitation and attraction data for a first partition of articles
1752: Memory device storing gravitation and attraction data for a second partition of articles
1753: Memory device storing gravitation and attraction data for a third partition of articles
1754: Memory device storing gravitation and attraction data for a fourth partition of articles
1800: Alternative implementation of Module-III of the software system of FIG. 5
1900: Processing tracked article-access information using multiple processors
1920: Incidence of article-access detection
1930: Processing time interval relevant to a single article-access detection
1940: Number of concurrent process upon detection of a respective article access
1950: Waiting time in a buffer due to unavailability of a free processor
2000: Arrangement for communicating article-succession records to processors and identifiers of complementing articles to registry 180 of active users
2060: Dual selector connecting the plurality of processors 930 to registry 180
2061: Article-succession records sent from registry 180 to the plurality of processors 930
2062: Identifiers of complementing article sent from the plurality of processors 930 to registry 180
2205: Indices of individual articles of a plurality of articles
2210: A collection of primary articles
2200: A collection of secondary articles
2240: Primary article pairs
2260: Article pairs each pair including a primary article and a secondary article
2280: Secondary article pairs
2300: Data structure for organizing composite affinity coefficients used for subsequent-article recommendation
2310: Organization of affinity data relevant to a reference article and a user belonging to a specific cluster of users
2312: data segment corresponding to a successor article
2320: Article rank in a list of preferred articles of high composite affinity levels to a reference article
2330: Identifier of a candidate article
2340: Value of a composite affinity coefficient
2350: An index range used for weighted random selection of a preferred article
2410: Word vectors of a number of articles
2420: Matrix of inter-article similarity coefficients
2425: Inter-article similarity coefficient within matrix 2420
2430: Index of an array storing content of matrix 2420
2440: Array of inter-article similarity coefficients
2500: A chart depicting envisaged users' compliance with article recommendations

### Terminology

Article: The term refers to any computer readable file which may comprise a text, drawings, pictures, an audio signal, or a video signal.

Complementing article: An article having a high-level of similarity as well as frequent succession to a reference article is referenced as a complementing article (or favorite article). A reference article and its complementing article may have a moderate level of similarity but a high frequency of transition from the reference article to the complementing article.

Article's metadata: When access to an article is detected, the system of the invention acquires information relevant to both the article and a network user accessing the article. The information may include an identifier of the article, data characterizing the article, an identifier of the user and data charactering the user. The acquired information is collectively referenced as the article's metadata.

Article's characterization data: The term refers to content of an article and/or metadata of the article such as “author”, “language”, “topic”, “file-size”, etc. The topic may be one of predefined classifications such as art, sports, travel, cooking, politics, philosophy, history, computing, finances, etc.

User's characterization data: A user may be characterized according to the user's affiliation with one of a predefined number of clusters and, possibly, the user's proximity to the centroid of the cluster.

Usage data: Usage data comprises identifiers of accessed articles and succession of articles accessed by a same user

Reference article: When a user accesses a first article then a second article, the first article is said to be the reference article.

Inter-article similarity level: The similarity level of two articles is a measure of resemblance between the contents of the two articles or complementariness of the two articles where the two articles are of the same topic. Known techniques may be applied to determine a similarity measure of two word files. For a collection of a large number of articles (tens of thousands, for example), content similarity may be assessed for an article pair only after inspecting the articles metadata; for example, there is no point in comparing lengthy contents of an article on cooking and an article on philosophy. Metadata comparison may also be appropriate for determining similarity between a lengthy text file and a video file containing few words; there would a high level of similarity between an article on the benefits of Yoga and a video recording of Yoga poses. Thus, a user who accesses a word article may be directed to an audio article or a video article, and vice versa.

Inter-article gravitation score: The term refers to a count of incidences of successive articles accessed by a same user regardless of the characteristics of the user.

Inter-article attraction score: The term refers to a count of incidences of successive articles accessed by a same user taking into account the user's affiliation with a cluster and possibly proximity of the descriptors of the user to the descriptors of the centroid of the cluster.

Composite affinity coefficient: For a directed article pair and a specific user characteristic, a composite affinity coefficient is determined as a function of the similarity coefficient and the gravitation score of the article pair, as well as the attraction score which depends on the user's characteristics. Where the user's characteristic is unknown, the composite affinity coefficient is determined as a function of only the similarity coefficient and the gravitation score of the article pair.

Bulk data: The term refers to similarity coefficients, gravitation scores, and attraction scores between a reference article and a number of potential successor articles.

Concise data: The term refers to significant composite affinity coefficients between a reference article and candidate successor articles.

Information dissemination system (or network): The term refers to any medium, such as the Internet, which provides users' access to articles.

Information tracking system: The term refers to apparatus and means for interaction with an information dissemination system to identify patterns of users' access to information

### DETAILED DESCRIPTION

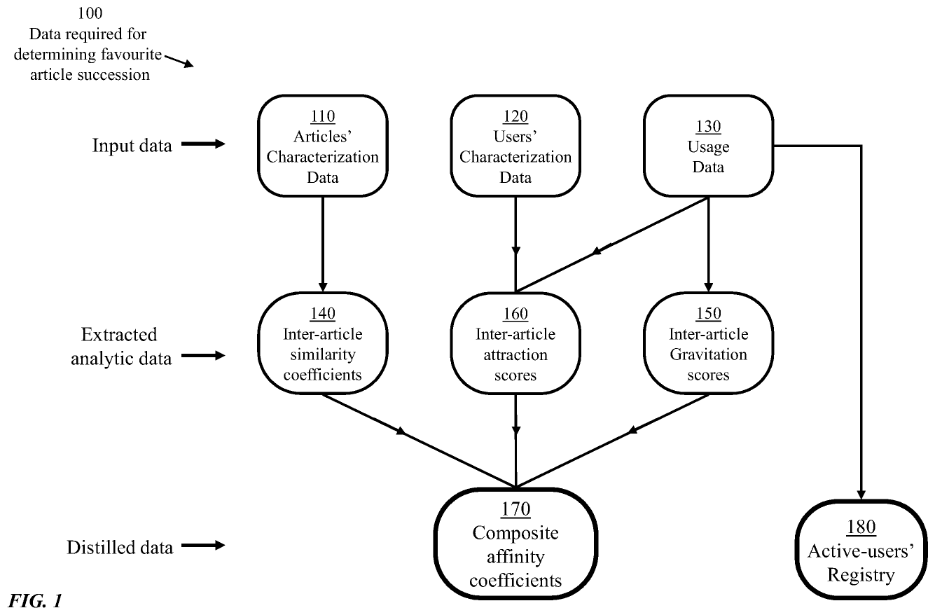

FIG. 1 illustrates requisite data 100 for enabling identification of inter-related articles from among a massive collection of articles. Input data comprising article characterization data 110, users' characterization data 120, and usage data 130 are processed to produce analytic data comprising inter-article similarity coefficients 140, inter-article gravitation scores 150, and inter-article attraction scores 160.

The article characterization data 110 includes articles' metadata as well as pointers to a storage medium where articles' contents can be acquired or network address for retrieving articles' contents. The users' characterization data 120 includes identifiers of clusters of users. A user may be characterized according to the user's affiliation with a cluster and the user's proximity to the centroid of the cluster. The usage data 130 includes identifiers of accessed articles and succession of articles accessed by a same user.

The inter-article similarity coefficients 140 are determined by comparing articles' contents using methods well known in the art. The inter-article gravitation data 150 is based on tracking successive articles accessed by a same user regardless of the characteristics of the user. The inter-article attraction data 160 is based on tracking successive articles accessed by a same user taking into account the user's affiliation with a cluster and proximity of the descriptors of the user to the descriptors of the centroid of the cluster.

A composite affinity coefficient 170 for a particular user and a directed article pair may then be determined as a function of the similarity coefficient and the gravitation score of the article pair, as well as the attraction score which depends on the user's characteristics.

An active-users' registry 180 is determined from the usage data 130. The registry identifies users accessing an article during a moving time window or identifies a most recently tracked number of users. For example, the registry may retain information relevant to the last 1000 users.

PCT applications PCT/CA2017/000145 and PCT/CA2017/000144 disclose methods for interacting with an Information Dissemination System, which may be accessed through a network, to determine and recommend to users of a network respective articles to access following inspection of any article of a collection of articles. The contents of applications PCT/CA2017/000145 and PCT/CA2017/000144 are incorporated herein by reference in their entirety.

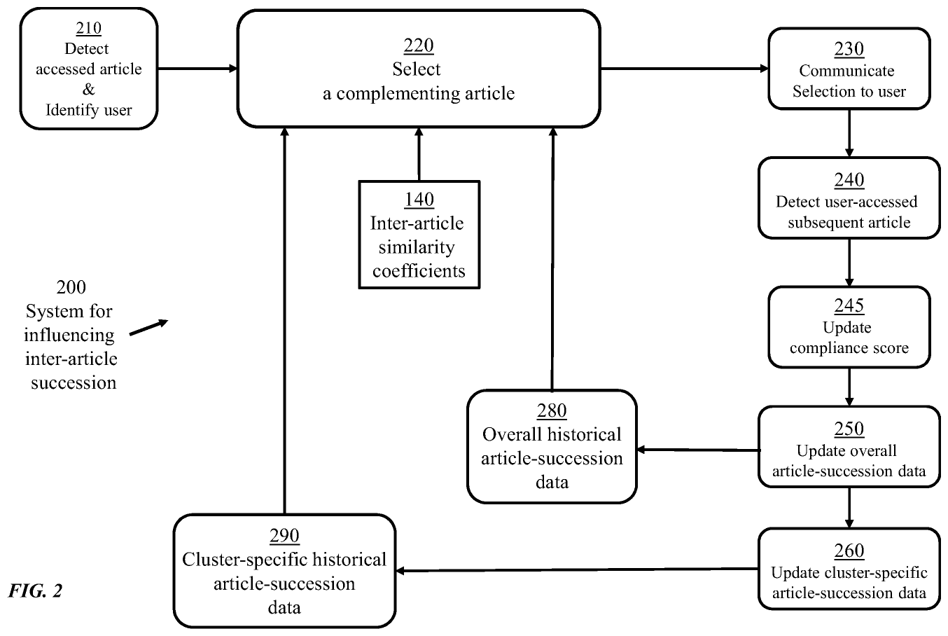

FIG. 2 illustrates an apparatus 200 for guiding article selection from a plurality of articles. The apparatus employs at least one hardware processor to perform processes for determining for each article of a plurality of article a complementing article to be recommended to a respective user, tracking successive article selections of users, and determining inter-article affinity levels for use in determining complementing articles.

Process 210 detects an accessed article and identifies a user accessing the article; data identifying an article and associated user are also references as an article's metadata. Process 220 selects a complementing article for a user accessing a current article. Process 230 communicates an identifier of a complementing article to a user. Process 240 detects a subsequent article accessed by same user, or equivalently, identifies a pair of successive articles accessed by a specific user. Process 245 updates a compliance score when a user actually selects a recommended article. Process 250 updates overall (global) article-succession data for the entire population of users. Process 260 updates article-succession data relevant to users belonging to a specific cluster of users.

The updated overall historical article-succession data 280 (also called “gravitation score”) and the cluster-specific historical article-succession data 290 (also called “attraction score”) are used, together with inter-article similarity data to determine complementing articles in process 220.

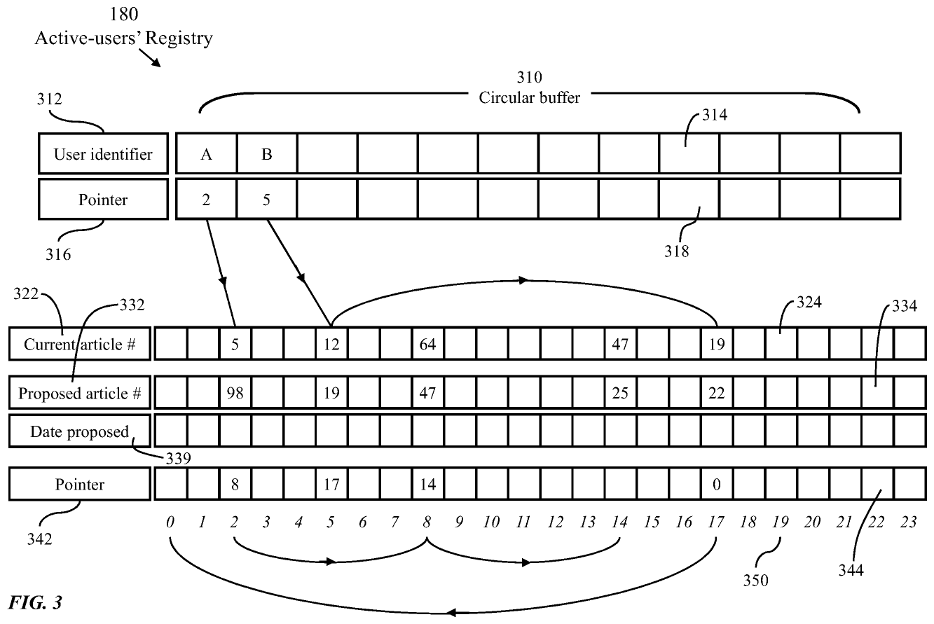

FIG. 3 illustrates an exemplary form of active-users registry 180 used to facilitate tracking a user's successive access to articles. A circular buffer 310 stores identifiers 314 of tracked users (user identifier field 312) and corresponding initial index 318 of a linked list (user registration field 316). The circular buffer holds data for a maximum of a predefined number of active users. A linked list of data segments relevant to three fields: a currently-accessed-article data field 322, a proposed-article data field 332, and a linked-list pointer 342. Thus, each data segment contains an identifier 324 of a currently accessed article by a respective user, an identifier 334 of an article recommended to the respective user, and an index 344 of relevant subsequent data for the specific user. A null entry 344 indicates absence of subsequent data for the user. Indices 350 of the linked list are indicated in the figure.

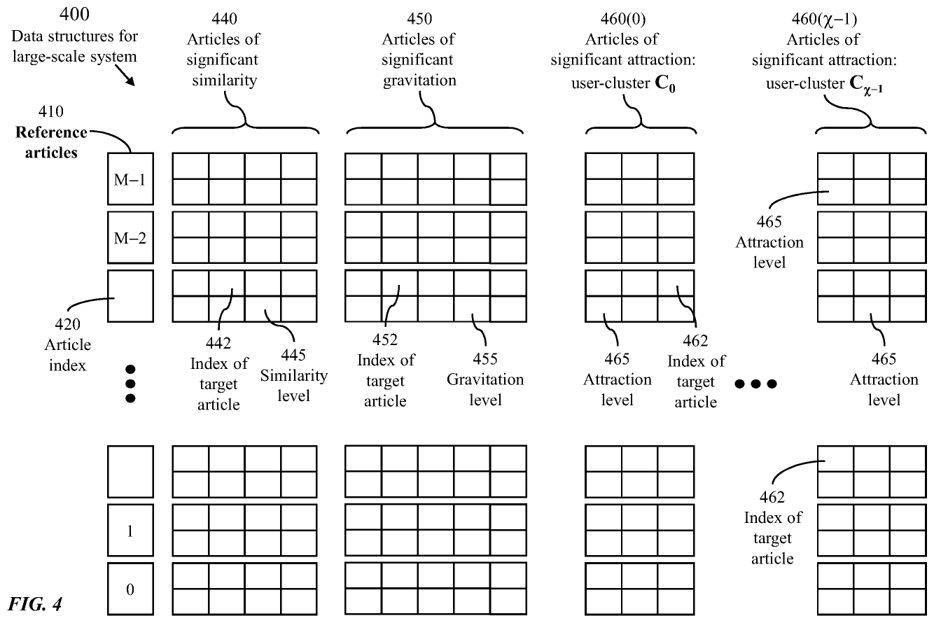

FIG. 4 illustrates data structures 400 for organizing data relevant to significant values of similarity coefficients, inter-article gravitation scores, and inter-article attraction scores for a plurality 410 of articles containing a relatively large number M of articles (several thousands for example).

A structure 440 organizes data relevant to candidate successor articles of significant similarity to respective reference articles. For each reference article 420, an index 442 of a candidate article and a corresponding content similarity level 445 to the reference article are stored.

A structure 450 organizes data relevant to candidate successor articles of significant gravitation to respective reference articles. For each reference article 420, an index 452 of a candidate article and a corresponding gravitation level 455 to the reference article are stored.

Structures 460(0) to 460(χ−1), χ>1, where χ is a number of clusters of users, organize data relevant to successor articles of significant attraction to respective reference articles for each user cluster. For each reference article 420, an index 462 of a candidate article and a corresponding gravitation level 465 to the reference article are stored.

FIG. 5 illustrates an apparatus 500 for determining complementing article successions for an information tracking system with sufficient usage data. The apparatus comprises at least one hardware processor and multiple memory devices storing article-related data and processor executable instructions.

A set of memory devices 140, 150, 160, and 170 stores inter-article affinity data. A set of memory devices stores processor executable instructions arranged into a number of modules.

A first module 520 employs at least one processor to select complementing articles to reference articles (a reference article is an article currently accessed by a user) of a plurality of articles based on composite inter-article composite affinity coefficients 170 derived from the inter-article affinity data.

A second module 540 employs at least one processor to update respective inter-article affinity data according to observed article successions to the reference articles. The second module updates a compliance score, inter-article gravitation scores 150, and inter-article attraction scores 160.

A third module 560 employs at least one processor to compute and update inter-article composite affinity coefficients 170 for directed article pairs based on updated inter-article similarity coefficients 140, gravitation scores 150, and attraction scores 160.

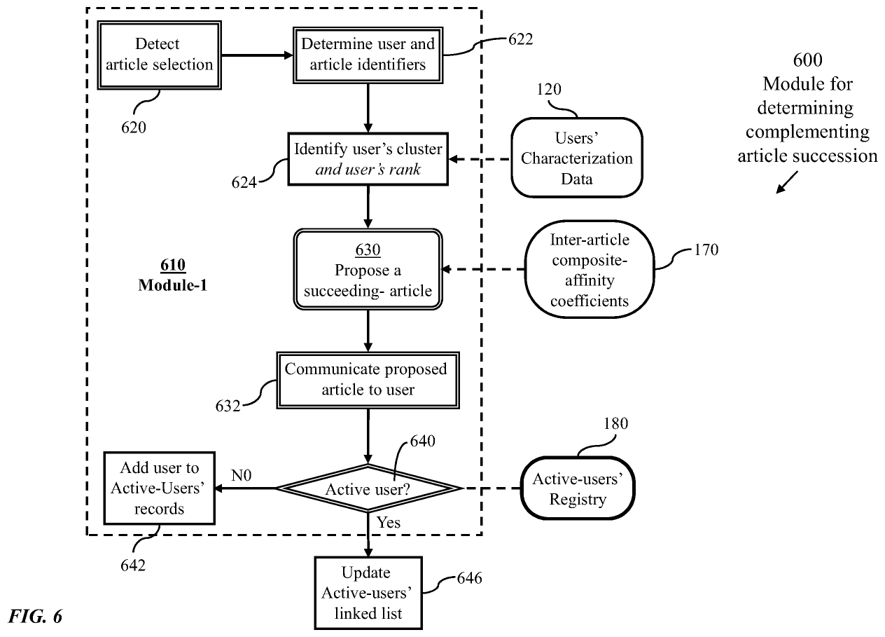

FIG. 6 illustrates a software system 600 for determining favourite article successions for an information tracking system with available inter-article similarity data but insufficient usage data. A module 610, hereinafter referenced as Module-I, comprises software instructions stored in a memory device which cause a processor to select one of preferred articles to complement a reference article (an article currently accessed by a user).

Upon detecting (process 620) a user accessing a particular article, the user is identified and the particular article is identified (process 622). The user may be characterized according to a respective user cluster if a cluster to which the user belongs is known (process 624). The characterization of the user may be further refined according to proximity of the user to the centroid of the cluster. A recommended article is selected (process 630) from a list of candidate articles each having a significant composite affinity coefficient with respect to the accessed article (reference article). Information relevant to the recommended article is communicated (process 632) to the user through a network interface.

Process 640 uses the Active-users' Registry 180 to determine whether the user is already registered. If the user is not registered, process 642 adds the user to the Active-users Registry and provides an initial linked-list pointer. Otherwise, process 640 proceeds to process 646 to update the linked list of the Active-users' Registry accordingly.

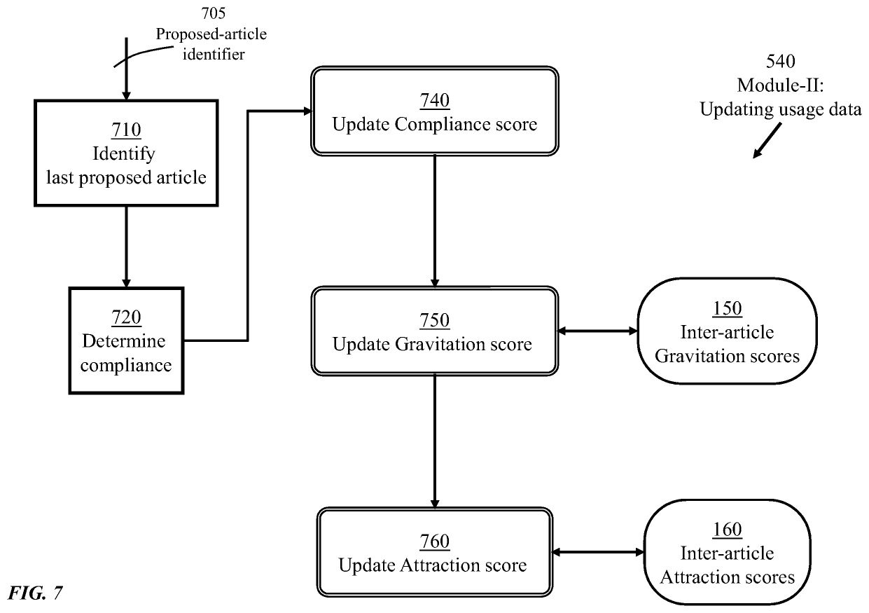

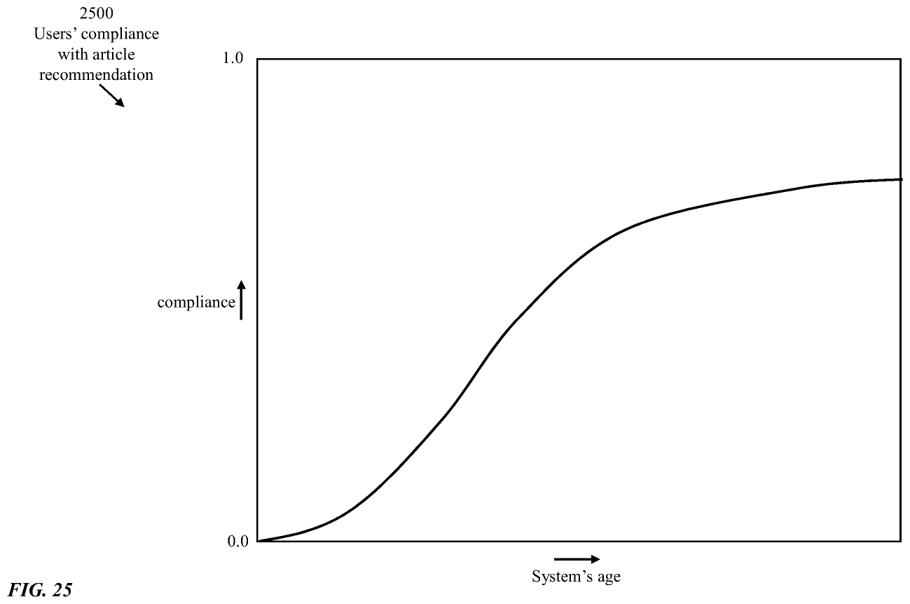

FIG. 7 illustrates a module for updating usage data (gravitation score and attraction score) as well as a compliance score. Software instructions 710 implement a process of determining the last article (most-recent article) recommended to a specific user and comparing the last recommended article with a current article that the user selected. For example, referring to FIG. 3, user “B” accessed article 19 after accessing article 12. When the use accessed article 12, the system recommended article 19. Thus, the user has complied with the recommendation. Where compliance is ascertained, process 740 updates a compliance score in order to measure the effect of providing recommendation to users as illustrated in FIG. 25.

Software instructions 750 update gravitation scores and software instructions 760 update updating attraction scores.

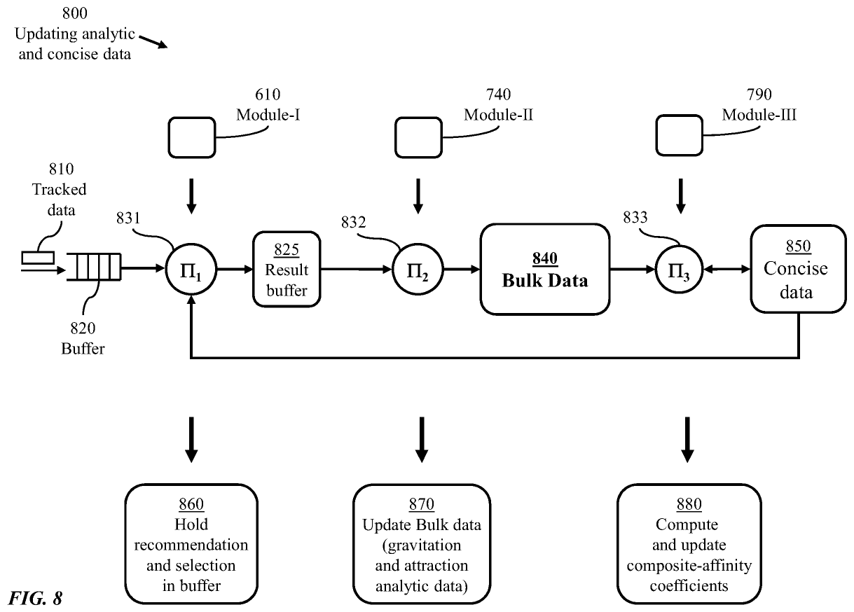

FIG. 8 illustrates an overview of an apparatus 800 for determining favourite article successions. A buffer 820 holds tracked data 810 received from a network interface (process 860). The tracked data comprises identifiers of articles currently accessed by users.

At least one processor 831, labelled Π₁, accesses memory device 850 storing composite affinity coefficients and executes instructions of Module-I (reference 610) to determine a favourite successor article for each currently accessed article. The recommended successor article and relevant data are held in a memory device 825.

At least one processor 832, labelled Π₂, accesses memory device 825 and storage medium 840, which may comprise multiple memory devices holding similarity data, gravitation and attraction scores, and executes instructions of Module-II (reference 740) to update (process 870) gravitation scores and attraction scores stored in storage medium 840.

At least one processor 833, labelled Π₃, accesses storage medium 840 and memory device 850 storing composite affinity coefficients, and executes instructions of Module-III (reference 790) to compute and update (process 880) the composite-affinity coefficients.

Thus, the present invention provides a method of guiding article selection from a plurality of articles accessible to a plurality of users. The method comprises processes of: initializing a compliance score; initializing a set of global article successions; and acquiring similarity metrics of each article to designated articles of the plurality of articles. Upon identifying a selected user accessing a specific article; a process of determining a complementing article to the specific article based on at least the similarity metrics and the set of global article successions which is based on detecting article access. An identifier of the complementing article is communicated to the selected user. Upon detecting access to a subsequent article by the selected user, the compliance score is updated and the set of global article successions is updated to account for a transition from the specific article to the subsequent article. Consequently, the method guides acquisition of information from a massive information source.

The method further comprises acquiring characteristics of each cluster of a set of predetermined clusters of users having access to the plurality of articles, initializing sets of cluster-specific article successions, each set of cluster-specific article successions corresponding to a respective cluster of users, and associating the selected user with a specific cluster.

A respective set of cluster-specific article successions corresponding to the specific cluster is updated and the process of determining the complementing article of the specific article is revised based on the similarity metrics, the set of global article successions, and the sets of cluster-specific article successions.

Data comprising the specific article, the complementary article, and a timestamp of communicating the identifier of the complementing article to the selected user is retained. A time interval between a time indication of detecting the subsequent article and the timestamp is determined and the compliance score is updated subject to a determination that the subsequent article matches the complementary article and the time interval is less than a predefined time threshold.

According to one implementation, the method further comprises segmenting the plurality of articles into a collection of primary articles and a collection of secondary articles; and selecting the designated articles from the collection of primary articles. Thus, the complementing article is restricted to be within the collection of primary articles.

The invention provides an apparatus for guiding article selection from a plurality of articles. According to an embodiment, the apparatus comprises a first set of memory devices storing inter-article affinity data and a second set of memory devices storing processor executable instructions. The instructions are arranged into three modules which may share a processor or—preferably—share respective processors.

A first module 520 causes a first processor (or a shared processor) to select complementing articles to reference articles of the plurality of articles based on inter-article affinity coefficients derived from the inter-article affinity data;

A second module 540 causes a second processor (or the shared processor) to update inter-article affinity data according to observed article successions to the reference articles.

A third module 560 causing a third processor (or the shared processor) to compute inter-article composite affinity coefficients based on the inter-article affinity data.

Therefore, the apparatus guides acquisition of information from an information source.

The first module is configured to identify a current user accessing a particular article (processes 620, 622), select a complementing article from the plurality of articles according to the composite affinity coefficients (process 630), and communicate information relevant to the complementing article to the current user (process 632). The first module is further configured to associate the current user with a respective cluster of a number of predetermined user clusters (process 624).

The second module is configured to identify latest preceding article accessed by the current user, increase an inter-article gravitation score of 2-tuple {latest-preceding-article, particular article}, and increase an inter-article attraction score of 3-tuple {latest-preceding-article, particular article, respective cluster}.

The second module is further configured to identify latest complementing article recommended to the user (process 710) and update a compliance score (process 740) subject to a determination that the particular article is the latest complementing article (process 720).

The first module is further configured to initialize a registry 180 of active users as an empty registry and enter the current user in the registry subject to a determination that the current user is not indicated in the registry.

For each directed article pair, the inter-article affinity data comprises a similarity coefficient 140, a gravitation score 150, and an attraction score 160. Each composite-affinity coefficient 170 is determined as a function of a similarity coefficient, a gravitation score, and an attraction score of a respective directed article pair.

In an optional implementation, the first module is further configured to segment the plurality of articles into a collection of primary articles 2210 and a collection of secondary articles 2220, and derive the inter-article affinity coefficients for only directed article pairs directed to primary articles 2210.

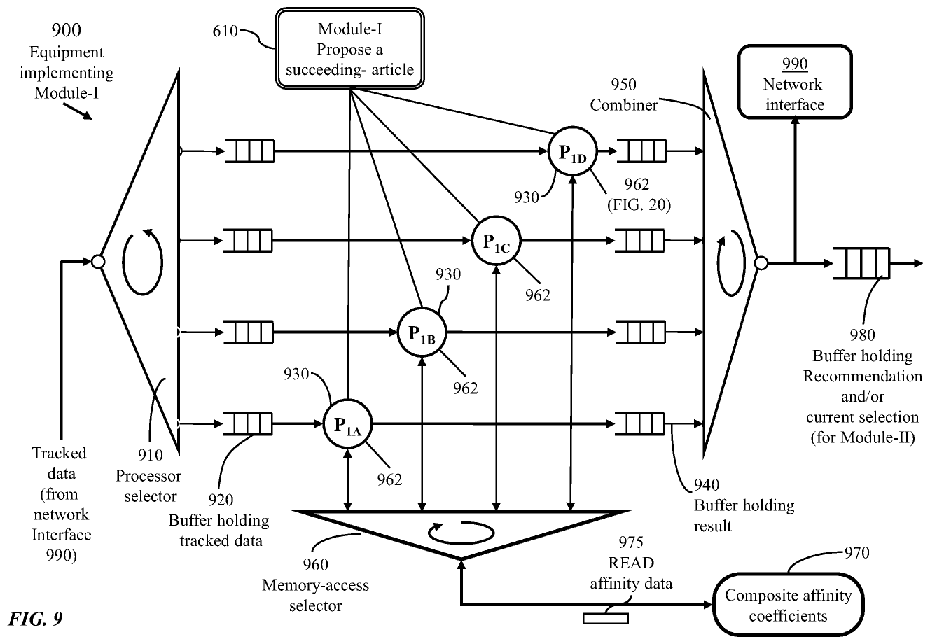

FIG. 9 illustrates equipment 900 implementing Module-I of the apparatus of FIG. 5 comprising multiple hardware processors for identifying a number of harmonious articles to follow a currently accessed article based on composite-affinity levels. In a large-scale information dissemination system, the rate of users' access to articles may be relatively high. Multiple processors may then be employed to determine favourite article successions. In the exemplary implementation of FIG. 9, the at least one processor Π₁ (reference 831) is selected as a set of processors 930 (P_{1A}, P_{1B}, P_{1C}, and P_{1D}). The tracked article-access data are cyclically distributed through a selector 910 to the four processors 930. Buffers 920 hold tracked data to be handled by respective processors 930. As illustrated, each processor 930 has access to Module-I. Preferably, each processor 930 is given exclusive access to a copy of Module-I stored in a respective memory device. The processors 930 cyclically access a memory device 970 storing the inter-article composite affinity coefficients 170 through a cyclic selector 960 to read specific composite affinity coefficients 975 for a specific reference article. The processing time of a processor 930 for a single detected article access is conceivably significantly larger than the memory-access time; hence the four processors 930 may share access to memory device 970. The recommendations produced by the four processors 930 are held in respective buffers 940 which may be cyclically combined into a single buffer 980 through a cyclic selector 950. A buffer 940 holds a message indicating user's identifier and an identifier of a recommended article determined by a processor 930. Buffer 980 holds data relevant to recommended articles, successor articles, and respective users to be communicated to users through a network interface and to be provided to Module-II for updating gravitation scores, attraction scores, and overall compliance scores.

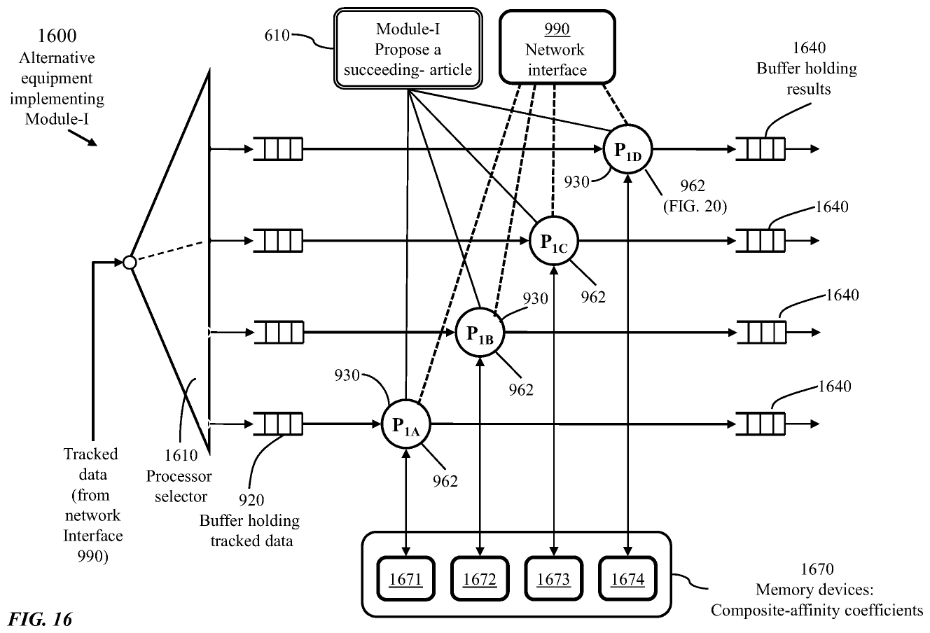

It is noted that due to the cyclic distribution of tracked data to the four processors 930, tracked data of several users accessing a particular reference article may be processed by different processors 930. In an alternative implementation illustrated in FIG. 16, tracked data relevant to a particular article is submitted to only one processor of a plurality of processors.

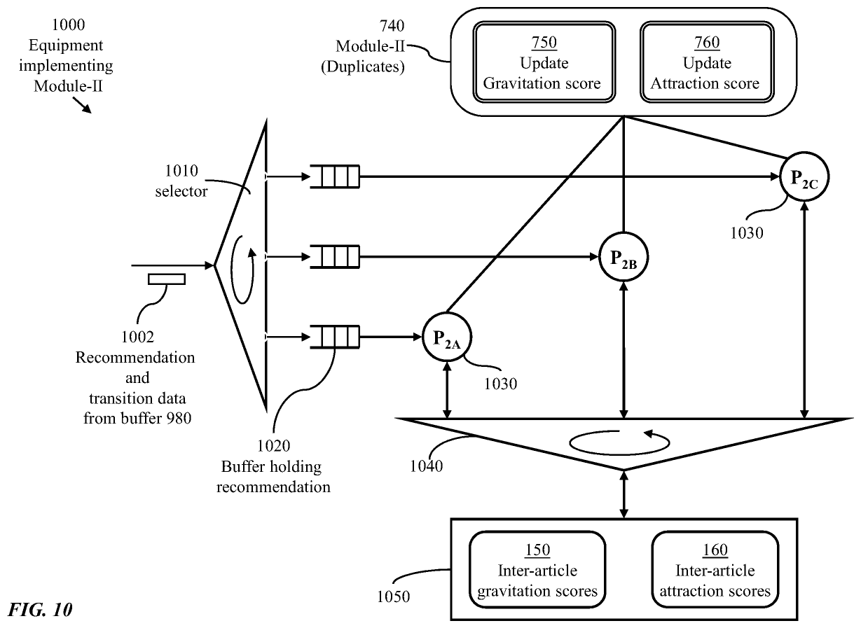

FIG. 10 illustrates equipment 1000 implementing Module-II of the apparatus of FIG. 5 employing multiple hardware processors for updating inter-article gravitation scores and attraction scores. In the exemplary implementation of FIG. 10, the at least one processor II₂ (reference 832) is selected as a set of processors 1030 (P_{2A}, P_{2B}, and P_{2C}).

Data 1002 relevant to recommended articles, successor articles, and respective users, read from buffer 980, is cyclically distributed through selector 1010 to processors 1030 preceding processors 1030. Selector 1040 cyclically connects processors 1030/P_{2A}, 1030/P_{2B}, and 1030/P_{2C} to memory devices 1050 holding inter-article gravitation scores 150 and inter-article attraction scores 160. Each processor 1030 executes instructions of Module-II to update the inter-article gravitation scores 150 and inter-article attraction scores 160.

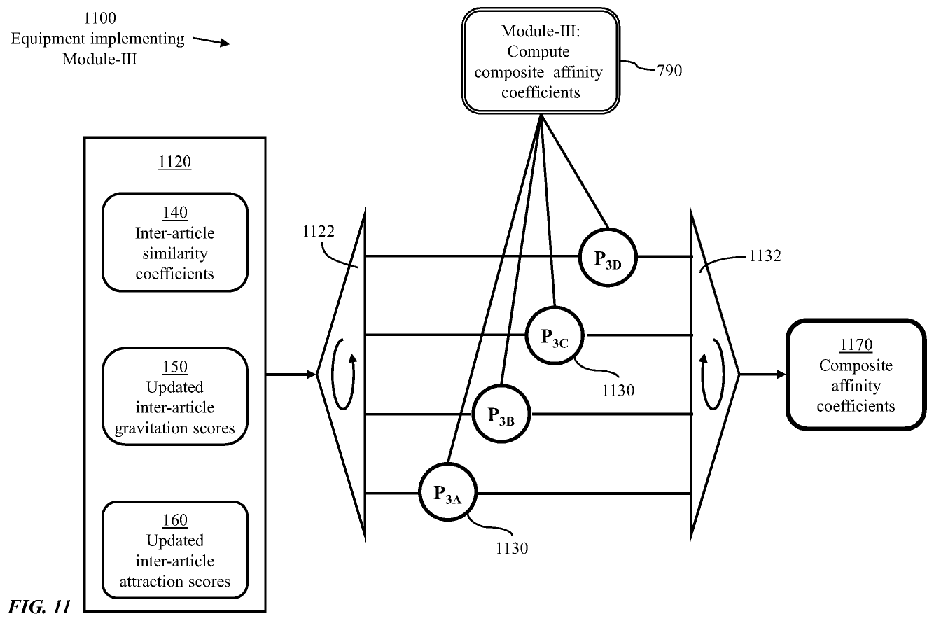

FIG. 11 illustrates equipment 1100 implementing Module-III of the software system of FIG. 5 where the at least one processor Π₃ (reference 833) is selected as a set of hardware processors 1130 (P_{3A}, P_{3B}, P_{3C}, and P_{3D}). The hardware processors 1130/P_{3A}, 1130/P_{3B}, 1130/P_{3C}, and 1130/P_{3D} generate or update the composite-affinity coefficients used in Module-I of the software system of FIG. 5. The composite-affinity levels are based on the inter-article similarity levels, the inter-article gravitation scores, and the attraction scores illustrated in FIG. 4. Storage medium 1120 comprises a memory device holding similarity coefficients as well as inter-article gravitation and attraction scores corresponding to respective sets of candidate successor articles for each article of the entire collection of articles. Storage medium 1170 holds composite affinity coefficients between each article of the entire collection of articles to respective candidate successor articles. Selector 1122 cyclically couples processors 1130/P_{3A}, 1130/P_{3B}, 1130/P_{3C}, and 1130/P_{3D} to memory device 1120 and selector 1132 cyclically couples processors 1130/P_{3A}, 1130/P_{3B}, 1130/P_{3C}, and 1130/P_{3D} to memory device 1170.

Apparatus 800 of FIG. 8 identifies harmonious article successions in a vast collection of articles accessible through an information-dissemination network. Module-I (reference 610) of the apparatus identifies a successor article complementing a reference article according to inter-article composite affinity coefficients 170. The composite affinity coefficients are based on article-characterization data and usage data. Starting with an initial collection of articles, inter-article similarity coefficients may be determined using (evolving) methods known in the art. Before sufficient usage data is accumulated, the selection of a successor article has to be based on similarity coefficients only. Thus, initially, the composite affinity coefficients are equated to similarity coefficients. Upon determining that sufficient usage data has been collected, inter-article gravitation levels and attraction levels can be determined from accumulated gravitation scores and attraction scores.

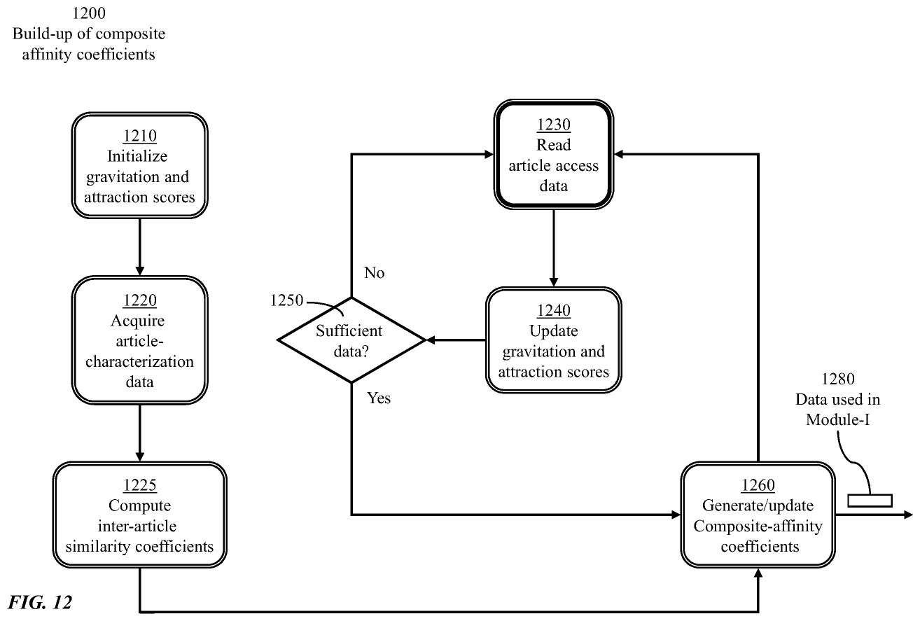

FIG. 12 illustrates processes 1200 of generating the composite affinity coefficients starting with inter-article similarity coefficients. To start, inter-article gravitation scores and attraction scores are zero initialized (process 1210) and article-characterization data of the initial collection of articles is acquired (process 1220). Inter-article similarity coefficients based on articles' contents may then be determined (process 1225) as illustrated in FIG. 4. A similarity coefficient may be defined to assume a value between 0.0 and 1.0 to indicate complete dissimilarity or complete similarity, respectively. A method of determining similarity based on content comparison may never produce a similarity of 1.0, unless an article is compared with itself, or a value of zero. However, similarity values below a predefined lower bound may be equated to zero. Thus, a matrix 420 for a large number of articles is likely to be a sparse matrix and only a relatively small number of successor articles may be considered for a reference article.

Apparatus 800 reads article-access data from buffer 820 (process 1230) and updates gravitation and attraction scores (process 1240). If Module-II (reference 740) determines that cumulative usage data is not sufficient to generate composite affinity coefficients (process 1250), the apparatus resumes reading article access data—if any—from buffer 820 (process 1230). Otherwise, composite affinity coefficients based on the similarity coefficients as well as gravitation scores and attraction scores are computed (process 1260) and the apparatus resumes reading article access data—if any—from buffer 820 (process 1230).

Thus, the method provides a method of guiding article selection from a plurality of articles accessible to a plurality of users. The method comprising: acquiring at a network interface 990 metadata of each detected article of a stream of detected articles belonging to the plurality of articles, the metadata being a tuple including an article identifier and an identifier of an associated; and cyclically distributing individual metadata of the stream of detected articles to multiple input buffers 920, each input buffer coupled to a respective processor 930 of a plurality of processors.

Each processor 930 executes instructions for: extracting metadata of a specific article stored in a respective input buffer; obtaining relevant affinity coefficients between the specific article and designated articles of the plurality of articles from a data memory 970 storing inter-article affinity coefficients 170; and determining a complementing article to the specific article based on the relevant affinity coefficients. An identifier of the complementing article is communicated to an associated user of the specific article. Therefore, the method guides information acquisition from a massive information source.

Obtaining the relevant affinity coefficients between the specific article and the designated articles comprises employing a dual selector 960 to cyclically connect the plurality of processors 930 to the data memory 970 and reading the relevant affinity coefficients from the data memory.

The method further comprises acquiring characteristics of each cluster of a set of predetermined clusters of the plurality of users and determining a specific cluster to which the associated user belongs.

The method further comprises updating a registry of active users indicating for each active user a respective sequence of accessed articles and corresponding complementing articles; an active user being a user that has accessed a detected article.

The method further comprises each processor accessing the registry of active users for: identifying latest preceding article accessed by the associated user, increasing an inter-article gravitation score of a 2-tuple {latest-preceding-article, specific article}, and increasing an inter-article attraction score of 3-tuple {latest-preceding-article, specific article, specific cluster}.

Each processor accesses the registry of active users to insert the identifier of the complementing article relevant to the associated user for use in determining a compliance score.

Generally, a composite affinity coefficient for a directed pair of a first article and a second article is determined as a function of a similarity metric of the first article and the second article, a gravitation score of the second article to the first article; and an attraction score of the second article to the first article for a specific cluster of users.

The invention provides an apparatus 900 for guiding article selection from a plurality of articles accessible to a plurality of users. The apparatus comprises: a plurality of hardware processors 930; a plurality of input buffers 920 each coupled to a respective processor 930 of the plurality of processors; and a data memory 970 storing inter-article affinity scores 150/160 and inter-article affinity coefficients 170.

A network interface, comprising a respective processor, executes instructions for detecting users' selection of articles through a network; and acquiring corresponding metadata.
A distributor 910 is configured to cyclically distribute metadata of detected articles to individual input buffers 930 of the plurality of input buffers.
A dual selector 960 is configured to cyclically provide two-way access of individual processors of the plurality of processors to the data memory.

Each processor 930 executes instructions to: identify a detected article and associated user from metadata held in a respective input buffer 920; determine a complementing article of the detected article based on relevant affinity coefficients 170 retrieved from the data memory 970; and communicate an identifier of the complementing article to the associated user through the network interface 990.

Therefore, the apparatus guides acquisition of information from an information source.

The apparatus further comprises a plurality of output buffers 940 each coupled to a respective processor 930 of the plurality of processors. The processors transfer identifiers of complementing articles to respective output buffers.

The apparatus further comprises a registry 180 of active users, coupled to the network interface 990, for storing article-selection data for active users, and a combiner 950 for cyclically distributing identifiers of complementing articles determined at the plurality of processors 930 to the network interface for transmission to respective users.

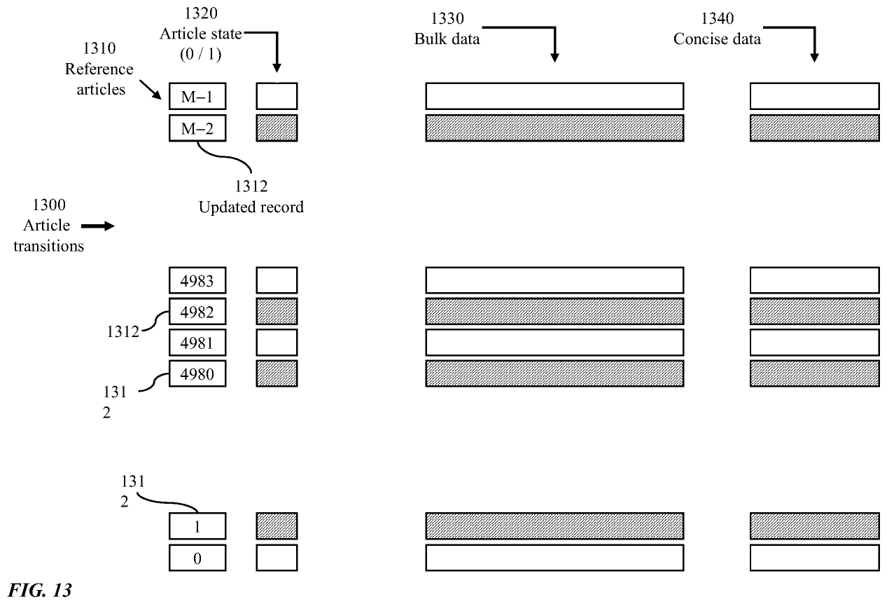

FIG. 13 illustrates exemplary article transitions 1300 necessitating bulk-data updates and concise data updates. The collection of articles comprises M reference articles 1310 indexed as 0 to (M−1). Bulk data 1330 comprising similarity coefficients, gravitation scores, and attraction scores from each reference article 1310 to a respective set of candidate articles are maintained in storage medium 840. Concise data 1340 comprising significant composite affinity coefficients of each reference article 1310 to selected candidate successor articles are maintained in a memory device 850.

Memory device 825 holds article transition data and recommended successor article. When a user accesses an article of index “Y” after accessing an article of index “X”, 0≤X<M, 0≤Y<M, the bulk data 1330 and concise data 1340 of the article of index X (reference 1312) are updated. The instructions of Module-I cause the at least one processor Π₁ (reference 831) to identify reference articles for which bulk data 1330 and concise data 1340 are to be updated. An article state 1320 indicates whether bulk data and concise data of an article need be updated. In the example of FIG. 13, four reference articles, referenced as 1312, require updates.

FIG. 14 illustrates a first scheme 1400 of articles' assignment to processors 930 executing Module-I for a case where the collection of articles contains a number, M, of articles bounded to a maximum value of 16384. The articles are indexed as 0 to 16383. The bulk-data comprises M data blocks each corresponding to a reference article and containing similarity data, gravitation data, and attraction data with respect to a respective set of articles as illustrated in FIG. 4. The concise data comprises M data blocks each corresponding to a reference article and containing composite affinity coefficients with respect to a respective set of articles as illustrated in FIG. 4. The collection of articles is divided into four partitions 1410 for storage in separate memory devices to facilitate concurrent processing where each memory device stores data relevant to a maximum of ┌M/4┐ articles.

FIG. 15 illustrates a second scheme 1500 of articles' assignment to processors 930 executing Module-I for an arbitrary number of articles which may change considerably as the information tracking system matures. The bulk-data comprises M data blocks each corresponding to a reference article and containing similarity data, gravitation data, and attraction data with respect to a respective set of articles as illustrated in FIG. 4. The concise data comprises M data blocks each corresponding to a reference article and containing composite affinity coefficients with respect to a respective set of articles as illustrated in FIG. 4. The collection of articles is divided into four partitions for storage in four memory devices to facilitate concurrent processing using four processors 930 executing Module-I. With the four memory devices indexed as 0, 1, 2, and 3, data relevant to an article of index J, 0≤J<M, is stored in a memory device of index j (reference 1512), where j=J_{modulo 4}. An advantage of the second scheme 1500 is that each memory device holds data of well spread articles. The articles may be indexed sequentially as acquired and, hence, the articles' indices reflect shifting interest. If the data of each memory device is to be processed by a same processor, then the second scheme 1500 naturally balances the processing loads of the processors. In the implementation of FIG. 9, load balancing is realized through cyclic distribution of tracked data to processors. Thus, each processor may handle tracked data relevant to any reference article. The objective of the alternative implementation of FIG. 16 is to enable partitioning the bulk data and concise data for storing in different memory devices to avoid memory-access contention where multiple processors vie for access to the bulk-data storage medium or concise-data storage medium.

FIG. 16 illustrates an alternative implementation 1600 of Module-I of the software system of FIG. 5. Instead of cyclic access to processors 930 as illustrated in FIG. 9, each processor handles articles of a respective partition of the plurality of articles.

In the exemplary implementation of FIG. 16, each processor 930 executes Module-I for a respective portion of reference articles. In the data organization of FIG. 14, the 16384 articles (M=16384) are divided into four groups of 4096 articles each. The tracked article-access data may be equitably distributed through a selector 1610 to the four processors 930/P_{1A}, 930/P_{1B}, 930/P_{1C}, and 930/P_{1D}. According to an implementation based on the data organization of FIG. 14, tracked data relevant to an article of index 0 to 4095 is directed to processor 930/P_{IA}, tracked data relevant to an article of index 4096 to 8191 is directed to processor 930/P_{1B}, tracked data relevant to an article of index 8192 to 12287 is directed to processor 930/P_{1C}, tracked data relevant to an article of index 12288 to 16383 is directed to processor 930/P_{1D}. According to an implementation based on the data organization of FIG. 15, tracked data relevant to an article of index J, 0≤J<M, is directed to processor 930/P_{1A} if j=J_{modulo4}=0, processor 930/P_{1B} if j=1, processor 930/P_{1C} if j=2, or processor 930/P_{1D} if j=3.

As in the implementation of FIG. 9, buffers 920 hold tracked data to be handled by respective processors 930. Each processor 930 has access to a copy of Module-I. Each processor 930 accesses a respective memory device 1670 (one of 1671, 1672, 1673, and 1674) storing the inter-article composite affinity coefficients 170 to read specific composite affinity coefficients for a specific reference article. The recommendations produced by the four processors 930 are held in respective buffers 1640. A buffer 1640 holds a message indicating user's identifier and an identifier of a recommended article determined by a processor 930 to be communicated to users through a network interface and to be provided to Module-II for updating gravitation scores, attraction scores, and overall compliance scores.

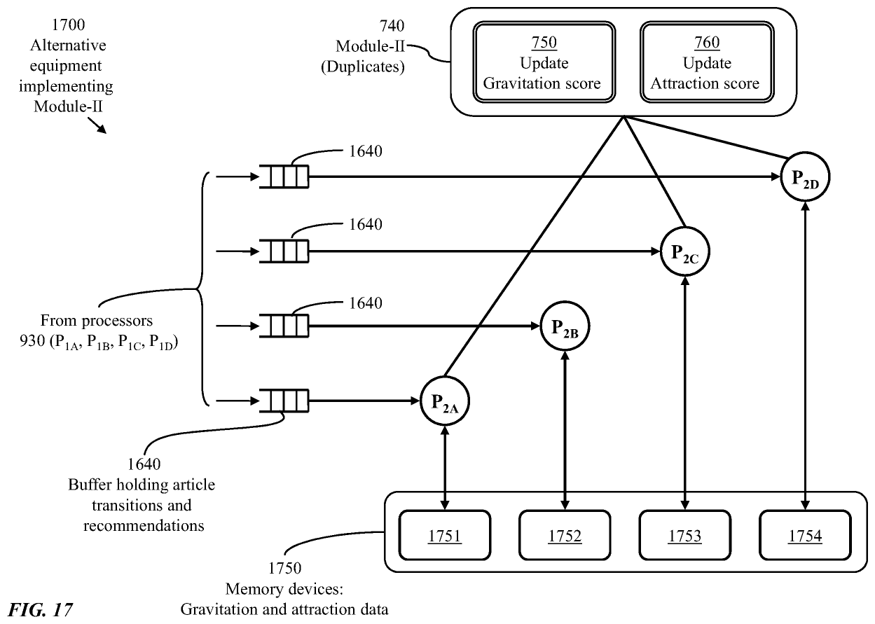

FIG. 17 illustrates equipment 1700 for an alternative implementation of Module-II of the software system of FIG. 5. A storage medium 1750 comprising four memory devices 1751, 1752, 1753, and 1754, each for holding similarity coefficients as well as inter-module gravitation and attraction scores for a respective partition of reference articles. The partitions are formed according to the scheme of FIG. 14 or the scheme of FIG. 15. Each of processors 1730/P_{2A}, 1730/P_{2B}, 1730/P_{2C}, and 1730/P_{2D} is directly coupled to a respective memory device 1750 and executes instructions relevant to recommended articles, successor articles, and respective users, read from a buffer 1640 to update gravitation and attraction scores for respective articles.

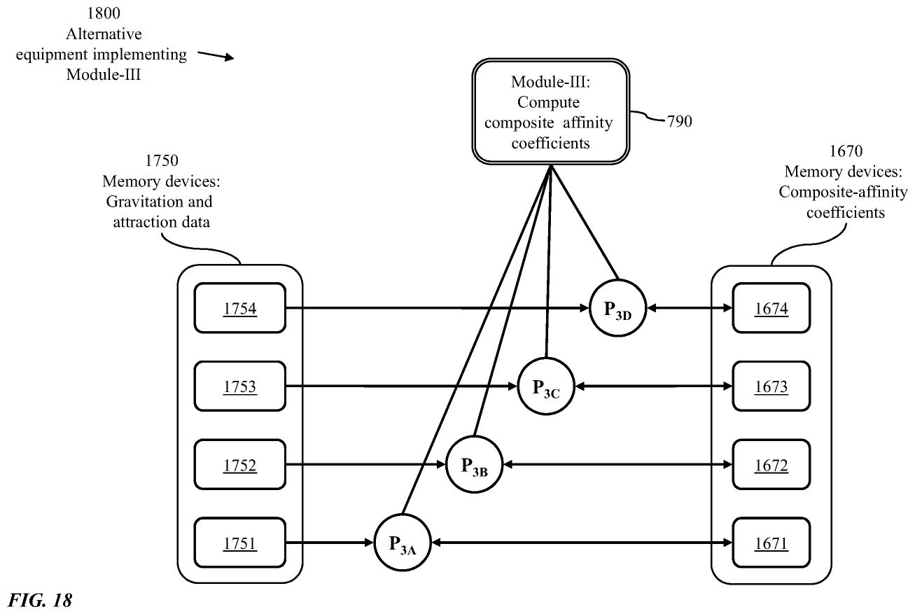

FIG. 18 illustrates equipment 1800 for an alternative implementation of Module-III of the software system of FIG. 5. Instead of cyclic access to processors 1130/P_{3A}, 1130/P_{3B}, 1130/P_{3C}, and 1130/P_{3D} as illustrated in FIG. 11, each processor handles articles of a respective partition of the plurality of article. With the collection of articles divided into four partitions as illustrated in FIG. 14 or FIG. 15, storage medium 1750 comprises four memory devices 1751, 1752, 1753, and 1754 and storage medium 1670 comprises four memory devices 1671, 1672, 1673, and 1674.

Memory devices 1751 stores similarity coefficients as well as inter-module gravitation and attraction scores for the first partition of reference articles. Memory devices 1671 stores inter-article composite affinity coefficients for the first partition of reference articles. Likewise, memory devices 1752 and 1672 store data relevant to the second partition, memory devices 1753 and 1673 store data relevant to the third partition, and memory devices 1754 and 1674 store data relevant to the fourth partition.

Processor 1130/P_{3A} is coupled to memory devices 1751 and 1671 and executes instructions of Module-III of the software system of FIG. 5 to update inter-article composite affinity coefficients for the first partition of articles. Likewise, Processor 1130/P_{3B}, 1130/P_{3C}, and 1130/P_{3D} update inter-article composite affinity coefficients for the second, third and fourth partitions of articles, respectively.

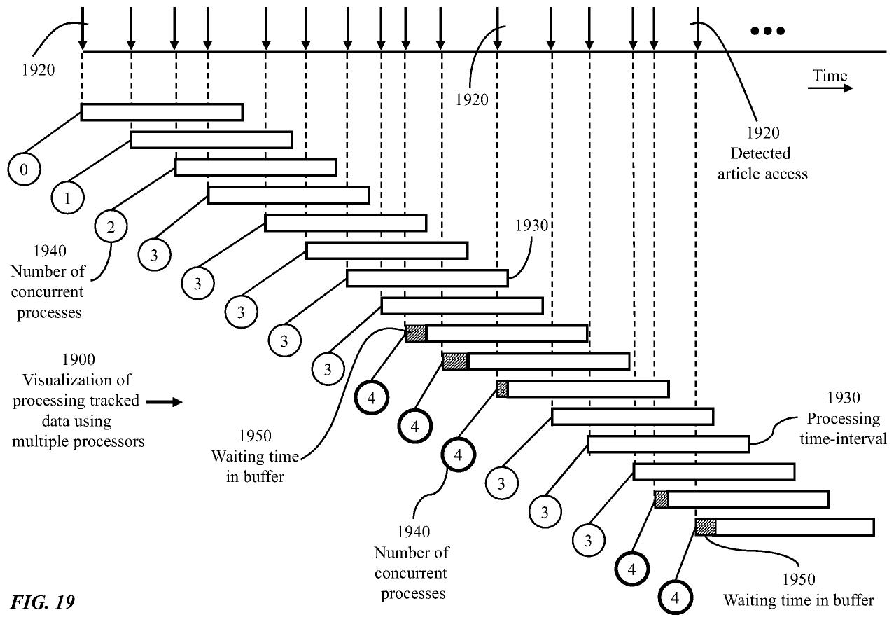

FIG. 19 illustrates timing of processes 1900 that follow detecting access of a sequence of articles in an apparatus 800. In the illustrated example, the processing time interval 1930 relevant to single article-access detection is substantially larger than the mean time between successive incidences 1920 of article access. Thus, multiple processors are employed for each of Module-I, Module-II, and Module-III where multiple processes can occur simultaneously. The processing time intervals 1930 may differ significantly for different incidences 1920.

Upon detecting an incidence 1920 of article access, data comprising an article's index and a user identifier is held in a buffer. If the number 1940 of concurrent processes is less than four, a processor is selected to determine, for the incidence data, a favourite successor article and update the gravitation and attraction data and possibly the composite affinity data. Otherwise, the incidence data remains in the buffer for a period 1950 until a processor becomes available. As illustrated, initially, the apparatus is idle. At the first incidence of article access, the number of concurrent processes is zero. At the second incidence, the number of concurrent processes is 1. At the eighth incidence, the number of concurrent process is 3. However, at the ninth incidence, the number of concurrent processes is 4, and the incidence data is queued in a buffer for a period 1950. As illustrated, there are four incidences where incidence data are queued until a processor becomes available.

Let T₁, T₂, and T₃ denote the mean processing time intervals of processors 930, 1030, and 1130, respectively, per single article-access detection and δ denote the mean time interval between successive incidences of detecting article access.

For the configurations of FIG. 9, FIG. 10, and FIG. 11: the number of processors executing the instructions of Module-I is selected to be at least equal to ┌T₁/δ┐; the number of processors executing the instructions of Module-II is selected to be at least equal to ┌T₂/δ┐; and the number of processors executing the instructions of Module-III is selected to be at least equal to ┌T₃/δ┐.

For the configurations of FIG. 16, FIG. 17, and FIG. 18, each of the number of processors executing the instructions of Module-I, the number of processors executing the instructions of Module-II, and the number of processors executing the instructions of Module-III equals the number of partitions of the collection of articles (FIG. 14, FIG. 15). Thus, the number of partitions exceeds the largest of {┌T₁/δ┐, ┌T₂/δ┐, ┌T₃/δ┐}.

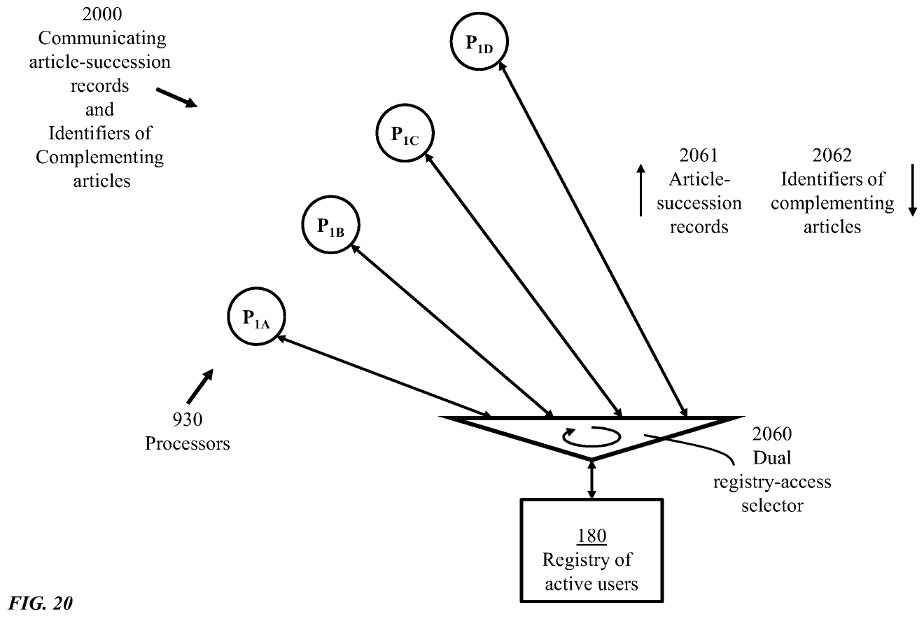

FIG. 20 illustrates cyclic connection of the multiple hardware processors 930 of the equipment of FIG. 9 or the equipment of FIG. 16 to the registry of active users in order to provide article-succession data (gravity data and attraction data) to the processors and insert identifiers of complementing articles into the registry of active users. Each processor 930 accesses the registry 180 to read article succession data 2061 for a respective user or insert an identifier of a complementing article for further use in determining compliance scores.

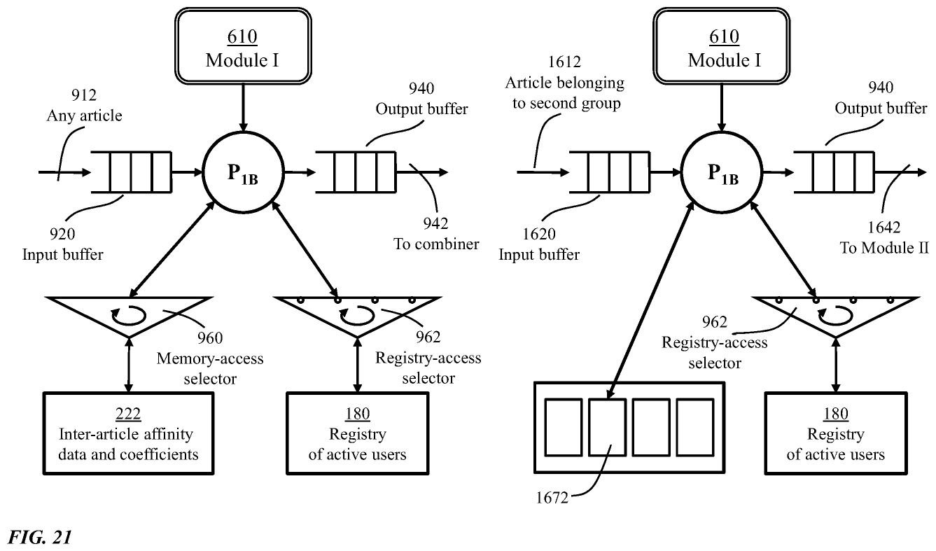

FIG. 21 illustrates connectivity of one of the processors of the equipment of FIG. 9 or the equipment of FIG. 16 to a memory device storing the inter-article affinity data and affinity coefficients illustrated in FIG. 4 and to the registry of active users illustrated in FIG. 3. A dual cyclic selector provides a two-way time-slotted path between each processor 930 and the registry 180 of active users (FIG. 3).

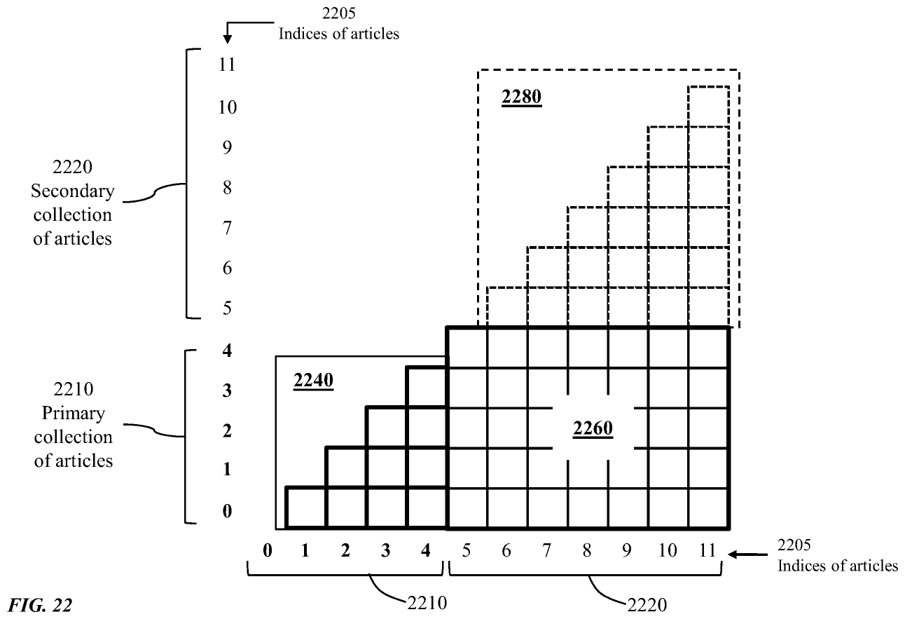

FIG. 22 illustrates segmenting a plurality of articles into a collection of primary articles and a collection of secondary articles for use in determining selective complementing articles. In the example of FIG. 22, the plurality of article comprises only 12 articles indexed as 0 to 12 (reference 2205); in an envisaged system, the number of articles would significantly higher. Five of the articles are designated as “primary articles” 2210 and the remaining seven articles are designated as secondary articles 2220.

Optionally, determining complementing articles may be restricted to exclude secondary articles. Thus, a complementing article may be determined for any reference article of the plurality article, but the complementing article would be constrained to be within the collection of primary articles.

Thus, the inter-article similarity coefficients are calculated for each pair of primary articles 2240 and for each pair of a primary article and a secondary article 2260. The inter-article similarity coefficients for pairs of secondary articles 2280 are not needed. Likewise, gravitation scores and attraction scores for article transitions to any secondary article need not be determined.

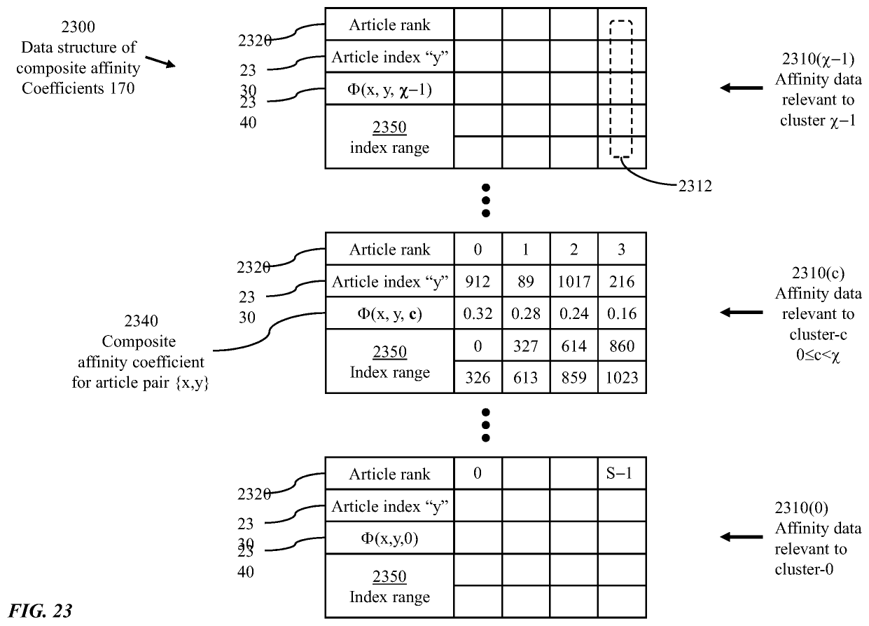

FIG. 23 illustrates a data structure 2300 for storing identifiers of favourite articles recommended to follow a reference article (a currently accessed article). Data structure 2300 organizes composite affinity coefficients used for subsequent-article recommendation. For each cluster of users, a data block 2310 holds affinity data relevant to the reference article and a user belonging to the cluster of users. Each data block 2310 contains a number S, S≥1, of data segments 2312 corresponding to the S-highest ranked candidates for a succeeding article. The number S is predefined; S=4 in the example of FIG. 23.

Article ranks 2320 in a list of preferred articles of high composite affinity levels to a reference article are preferably sorted on a descending order. Each data segment 2312 contains:

a candidate article's identifier 2330;

a value 2340 of a composite affinity coefficient (Φ(x,y,c)); and

an index range 2350 used for weighted random selection of a preferred article.

For example, data block 2310(c) stores information relevant to four candidate articles of indices 912, 89, 1017, and 216 of a list of accessible articles with corresponding composite-affinity coefficients of 0.32, 0.28, 0.24, and 0.16. The affinity coefficients correspond to partitions {0 to 326}, {327-613}, {614 to 859}, and {860 to 1023} of an array of 1024 entries that may be accessed randomly to select a “winning” subsequent article from the four candidate articles.

While data blocks of equal numbers of segments 2312 are illustrated, a person skilled in the art may use an alternative structure where the number of candidate articles, i.e., the number of data segments 2312, varies from one cluster of users to another.

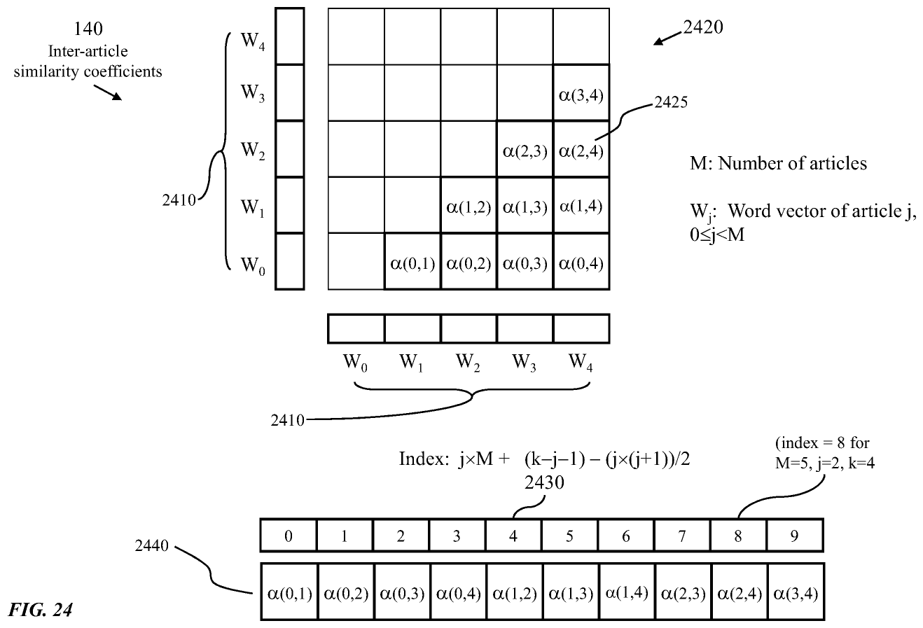

FIG. 24 illustrates inter-article similarity levels 140 based on articles' contents for a collection of only five articles (M=5). The contents of the five articles are denoted W(j), 0≤j<M. The content of an article may be represented as a word vector 2410. The article-content similarity levels 2425, denoted α(j, k), 0≤j<M, 0≤k<M, k≠j, for all pairs of articles may be organized in the form of a matrix 2420. The article-content similarity levels α(j, k) and α(k,j) are identical. Thus, only content-similarity levels corresponding to 0≤j<(M−1), 1≤k<M, k>j, need be stored. Naturally α(x, x)=1.0, 0≤x<M. Thus, the article-content similarity levels may occupy an array 2440 having M×(M−1)/2 entries where an article-content similarity level α(j,k), k>j, may be stored in array 2440 at a location 2430 determined as {j×M+(k−j−1)−(j×(j+1))/2}.

Thus, the present invention provides a method of guiding article selection from a plurality of articles accessible to a plurality of users. The method comprises: acquiring at a network interface 990 metadata of each detected article of a stream of detected articles belonging to the plurality of articles, the metadata being a tuple including an article identifier and an identifier of an associated; and distributing individual metadata of the stream of detected articles to a plurality of input buffers 920, each input buffer coupled to a respective processor 930 of a plurality of hardware processors 930, each assigned to a partition of articles of the plurality of articles.

Each processor 930 executes instructions for: extracting metadata of a specific article stored in a respective input buffer; obtaining relevant affinity coefficients between the specific article and designated articles of the plurality of articles from a data memory storing inter-article affinity coefficients 170 for a respective partition of articles to which the specific article belongs; and determining a complementing article to the specific article based on the relevant affinity coefficients. An identifier of the complementing article is communicated to an associated user of the specific article.

Consequently, the method guides information acquisition from a massive information source.

The method further comprises updating a registry of active users indicating for each active user a respective sequence of accessed articles and corresponding complementing articles, where an active user is a user that has accessed a detected article.

The method further comprises each processor accessing the registry of active users for: identifying latest preceding article accessed by the associated user; increasing an inter-article gravitation score of a 2-tuple {latest-preceding-article, specific article}; and increasing an inter-article attraction score of 3-tuple {latest-preceding-article, specific article, specific cluster}.

The processors access the registry of active users to insert identifiers of complementing articles relevant to respective users for use in determining a compliance score.

The invention provides an apparatus 1600 for guiding article selection from a plurality of articles accessible to a plurality of users. The apparatus comprises: a plurality of hardware processors 930, each designated for a partition of articles of the plurality of articles; and a plurality of input buffers 920 each coupled to a respective processor 930 of the plurality of processors.

A network interface 990, comprising a respective processor, executes instructions for: detecting users' selection of articles through a network; and acquiring corresponding metadata.

Each data memory of a plurality of data memory devices 1671, 1672, 1673, 1674, stores inter-article affinity scores 150, 160 and inter-article affinity coefficients 170 for a respective partition of articles.

A distributor 1610 distributes metadata of detected articles to respective processors of the plurality of processors. Each processor 930 is coupled to a respective data memory and executes instructions to: identify a detected article and associated user from metadata held in a respective input buffer; determine a complementing article of the detected article based on relevant affinity coefficients retrieved from the respective data memory 1671, 1672, 1673, or 1674; and communicate an identifier of the complementing article to the associated user through the network interface 990.

Therefore, the apparatus guides acquisition of information from an information source.

The apparatus further comprises a registry 180 of active users, coupled to the network interface 990, storing article-selection data for active users; and means for communicating identifiers of complementing articles determined at the plurality of processors 930 to the network interface for transmission to respective users.

The apparatus further comprises a plurality of output buffers 940 each coupled to a respective processor 930 of the plurality of processors. Each processor transfers identifiers of complementing articles to a respective output buffer for further processing.

The apparatus further comprises a dual cyclic selector 2060 for connecting the plurality of processors to the registry 180 of active users to enable communicating article-succession records from the registry to the plurality of processors and communicating identifiers of complementing articles to the registry of active users.

The apparatus further comprises at least one processor for determining inter-article composite-affinity coefficients, based on respective inter-article similarity levels, inter-article gravitation scores, and inter-article attraction scores, for directed pairs comprising each article of the plurality of articles to each article of a subset of articles designated as primary articles.

FIG. 25 illustrates envisaged users' compliance 800 with article recommendations determined by process 740 of FIG. 7. The chart depicts envisaged users' compliance with article recommendations. As the information tracking system matures, more usage data is accumulated and the successor-article recommendations more accurately represent users' interests.

The processes described above, as applied to a social graph of a vast population, are computationally intensive requiring the use of multiple hardware processors. A variety of processors, such as microprocessors, digital signal processors, and gate arrays, may be employed. Generally, processor-readable media are needed and may include floppy disks, hard disks, optical disks, Flash ROMS, non-volatile ROM, and RAM.

Systems of the embodiments of the invention may be implemented as any of a variety of suitable circuitry, such as one or more microprocessors, digital signal processors (DSPs), application-specific integrated circuits (ASICs), field programmable gate arrays (FPGAs), discrete logic, software, hardware, firmware or any combinations thereof. When modules of the systems of the embodiments of the invention are implemented partially or entirely in software, the modules contain a memory device for storing software instructions in a suitable, non-transitory computer-readable storage medium, and software instructions are executed in hardware using one or more processors to perform the techniques of this disclosure.

Numerous specific details have been set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

It should be noted that data and data output from the systems and methods described herein are not, in any sense, abstract or intangible. Instead, the data is necessarily digitally encoded and stored in a physical data-storage computer-readable medium, such as an electronic memory, mass-storage device, or other physical, tangible, data-storage device and medium. It should also be noted that the currently described data-processing and data-storage methods cannot be carried out manually by a human analyst, because of the complexity and vast numbers of intermediate results generated for processing and analysis of even quite modest amounts of data. Instead, the methods described herein are necessarily carried out by electronic computing systems on electronically or magnetically stored data, with the results of the data processing and data analysis digitally encoded and stored in one or more tangible, physical, data-storage devices and media.

Although specific embodiments of the invention have been described in detail, it should be understood that the described embodiments are intended to be illustrative and not restrictive. Various changes and modifications of the embodiments shown in the drawings and described in the specification may be made within the scope of the following claims without departing from the scope of the invention in its broader aspect.

1. A method of guiding article selection from a plurality of articles accessible to a plurality of users, the method comprising:
employing at least one processor for:
initializing a set of global article successions;
acquiring similarity metrics of each article to designated articles of said plurality of articles;
identifying a selected user accessing a specific article;
determining a complementing article to said specific article based on at least:
said similarity metrics; and
said set of global article successions;
communicating an identifier of said complementing article to said selected user;
detecting access to a subsequent article by said selected user;
and
updating said set of global article successions to account for a transition from said specific article to said subsequent article;
thereby, the method guides acquisition of information from a massive information source.

2. The method of claim 1 further comprising:
acquiring a set of predetermined clusters of said plurality of users;
initializing sets of cluster-specific article successions, each set of cluster-specific article successions corresponding to a respective cluster of users;
associating said selected user with a specific cluster;
updating a respective set of cluster-specific article successions corresponding to said specific cluster; and
revising said determining of said complementing article to said specific article based on:
said similarity metrics;
said set of global article successions; and
said sets of cluster-specific article successions.

3. The method of claim 1 further comprising:
retaining data for said selected user comprising said specific article, said complementary article, and a timestamp of said communicating;
determining a time interval between a time indication of said detecting and said timestamp;
updating a compliance score subject to a determination that:
said subsequent article matches said complementary article; and
said time interval is less than a predefined time threshold.

4. The method of claim 1 further comprising:
segmenting said plurality of articles into a collection of primary articles and a collection of secondary articles; and
selecting said designated articles from said collection of primary articles;
said determining comprising a step of restricting said complementing article to be within said collection of primary articles.

5. An apparatus for guiding article selection from a plurality of articles, the apparatus comprising:
a first set of memory devices storing inter-article affinity coefficients; and
a second set of memory devices storing processor executable instructions forming:
a first module causing a first processor to select complementing articles to reference articles of said plurality of articles based on inter-article affinity coefficients initialized as predetermined inter-article similarity coefficients;
a second module causing a second processor to update inter-article transition scores according to observed article successions to said reference articles; and
a third module causing a third processor to refine said inter-article affinity coefficients based on said inter-article transition scores;
thereby, the apparatus guides acquisition of information from an information source.

6. The apparatus of claim 5 wherein said first module is configured to:
identify a current user accessing a particular article;
select a complementing article from said plurality of articles according to said inter-article affinity coefficients;
communicate a recommendation to access the complementing article to the current user.

7. The apparatus of claim 6 wherein:
said first module is further configured to associate the current user with a respective cluster of a number of predetermined user clusters;
said second module is configured to:
identify latest preceding article accessed by said current user;
increase an inter-article gravitation score of 2-tuple {latest-preceding-article, particular article} as a global usage-based measure of affinity of the particular article to the latest-preceding-article; and
increase an inter-article attraction score of 3-tuple {latest-preceding-article, particular article, respective cluster} as a focused usage-based measure of affinity of the particular article to the latest-preceding-article.

8. The apparatus of claim 6 wherein said second module is further configured to:
identify latest complementing article recommended to the user; and
update an overall compliance score subject to a determination that the particular article is the latest complementing article recommended to the current user.

9. The apparatus of claim 6 wherein said first module is further configured to:
initialize a registry of active users as an empty registry;
enter the current user in the registry subject to a determination that the current user is not indicated in the registry.

10. The apparatus of claim 7 wherein:
each said inter-article affinity coefficient for a directed pair of a first article and a second article is determined as a function of:
a similarity coefficient of the first article and the second article;
a gravitation score of said second article to said first article; and
an attraction score of said second article to said first article.

11. The apparatus of claim 5 wherein said first module is further configured to:
segment said plurality of articles into a collection of primary articles and a collection of secondary articles; and
derive said inter-article affinity coefficients for only directed article pairs directed to primary articles.

12-18. (canceled)

19. An apparatus for guiding article selection from a plurality of articles accessible to a plurality of users, the apparatus comprising:
a plurality of hardware processors;
a plurality of input buffers each coupled to a respective processor of said plurality of processors;
a data memory storing article-succession data and inter-article affinity coefficients initialized as predetermined inter-article similarity coefficients;
a network interface configured to:
detect users' selection of articles through a network; and
acquire corresponding metadata;
a distributor for cyclically distributing metadata of detected articles to individual input buffers of said plurality of input buffers;
a dual selector for cyclically providing two-way access of individual processors of said plurality of processors to said data memory;
each said processor executing instructions to:
identify a detected article and associated user from metadata held in a respective input buffer;
determine a complementing article of said detected article based on relevant affinity coefficients retrieved from said data memory; and
communicate an identifier of said complementing article to said associated user through said network interface;
thereby, the apparatus guides acquisition of information from an information source.

20. The apparatus of claim 19 further comprising a plurality of output buffers each coupled to a respective processor of said plurality of processors, said respective processor transferring said identifier of said complementing article to a respective output buffer.

21. The apparatus of claim 19 further comprising:
a registry of active users, coupled to said network interface, storing article-selection data for active users detected at said network interface; and
a combiner for cyclically distributing identifiers of complementing articles determined at said plurality of processors to said network interface for transmission to respective users.

22-25. (canceled)

26. An apparatus for guiding article selection from a plurality of articles accessible to a plurality of users, the apparatus comprising:
a set of hardware processors, each processor designated for a partition of articles of said plurality of articles;
a plurality of input buffers each coupled to a respective processor of said set of processors;
a network interface configured to:
detect users' selection of articles through a network; and
acquire corresponding metadata;
a plurality of data memory devices, each storing article succession data and inter-article affinity coefficients initialized as predetermined inter-article similarity coefficients for a respective partition of articles;
a distributor for distributing metadata of detected articles to respective processors of said set of processors;
said each processor coupled to a respective data memory and executing instructions to:
identify a detected article and associated user from metadata held in a respective input buffer;
determine a complementing article of said detected article based on relevant affinity coefficients retrieved from said respective data memory; and
communicate an identifier of said complementing article to said associated user through said network interface;
thereby, the apparatus guides acquisition of information from an information source.

27. The apparatus of claim 26 further comprising:
a registry of active users, coupled to said network interface, storing article-selection data for active users detected at said apparatus; and
a module for communicating recommendations to access complementing articles determined at said set of processors to respective users through said network interface.

28. The apparatus of claim 26 further comprising a plurality of output buffers each coupled to a respective processor of said set of processors, said respective processor transferring said identifier of said complementing article to a respective output buffer for further processing.

29. The apparatus of claim 26 further comprising a dual cyclic selector for connecting said set of processors to said registry of active users to enable communicating article-succession records from the registry to the set of processors and communicating identifiers of complementing articles to the registry of active users.

30. (canceled)

31. The apparatus of claim 26 further comprising a module configured to:
associate each user of the plurality of users with a respective cluster of a number of predetermined user clusters; and
continually refine said inter-article affinity coefficients as a function of said predetermined inter-article similarity coefficients and article successions for users belonging to a same cluster.

32. The apparatus of claim 26 further comprising a module for increasing an overall compliance score subject to a determination that a user selects a recommended complementary article within a predefined time threshold.
